(19) United States
(12) Patent Application Publication
(10) Pub. No.: US 2003/0208490 A1
(43) Pub. Date: Nov. 6, 2003

(54) System and method for data storage, control and access

(76) Inventors: Jean-Jacques Larrea, Brooklyn, NY (US); Benjamin I. Goldhagen, New York, NY (US); Michael J. O'Toole, Tinton Falls, NJ (US); Erik K. Grimmelmann, New York, NY (US)

Correspondence Address: CUMMINGS & LOCKWOOD, Four Stamford Plaza, P.O. Box 120, Stamford, CT, 06904-0120, US

(21) Appl. No.: 10/166,118

(22) Filed: Jun. 10, 2002

Related U.S. Application Data
(60) Provisional application No. 60/298,443, filed on Jun. 15, 2001.

(51) Int. Cl. G06F 7/00

(52) U.S. Cl. 707/9

(57) ABSTRACT

The present disclosure relates to a system and method for improved data (or information) storage, control and/or access. A system/method according to the disclosure facilitates enhanced versioning of data files, data records, information, and the like, such that subsequent data file and/or record retrieval is consistent with and reflective of ancillary conditions at the time of the data file and/or record input. The system/method provides enhanced data/information storage, control and access that have applicability in a variety of fields, including applications related to health care, mental health care, financial and accounting systems, industrial control systems, and the like.

### BACKGROUND OF THE DISCLOSURE

1. Cross Reference to Related Applications

The present application claims the benefit of a co-pending provisional patent application, entitled “System and Method for Data Storage, Control and Access,” that was filed on Jun. 15, 2001, and assigned Serial No. 60/298,443. The entire content of the foregoing provisional patent application including, without limitation, Exhibit A thereto, is incorporated herein by reference.

2. Technical Field

The present disclosure relates to a system and method for improved data (or information) storage, control and/or access. More particularly, the present disclosure relates to a system/method that facilitates enhanced versioning of data files, data records, information, and the like, such that subsequent data file and/or record retrieval is consistent with and reflective of ancillary conditions at the time of the data file and/or record input. The system/method of the present disclosure provides enhanced data/information storage, control and access that have applicability in a variety of fields, including applications related to health care, mental health care, financial and accounting systems, industrial control systems, and the like.

3. Discussion of Background Art

In an information or data entry/storage system, there is generally a prior “baseline” state of the operating information or data held within the system. At a point in time, a user of the system, e.g., a decision-maker, can review some or all of the existing baseline information in order to formulate a decision. Similarly, a user of the system may undertake to input new, amended, revised and/or updated data/information to the system, or delete information/data contained in the system. The user introduces a tentative change to the existing information/data contained within the system by introducing into the information system what may be termed a “transaction”—a container tying together a number of discrete changes (potentially including additions, modifications and deletions) to the baseline state as a simultaneous event.

By committing the transaction, the user ratifies the proposed changes, merging these changes to the baseline state of the system and “publishing” them so that such changes are subsequently available to one or more additional users or additional classes of users of the system, e.g., consumers. Such additional users (consumers) may base subsequent decision-making with legal, safety, financial, ethical and/or other implications on the changes made or unmade to the baseline state of the system. Additional users may also introduce further changes to the system (e.g., additional transactions) which are dependent on and influenced by such prior transactions.

For example, in a healthcare information system, users are routinely creating, updating, revising and/or modifying patient records to reflect developments associated with the patient. These developments may relate to health issues, payment and insurance issues, contact information (such as address/phone number), and the like. In the area of health issues, a “transaction” within the data/information system may involve entering a new diagnosis, or modifying or removing an existing diagnosis. Other caregivers and/or health care providers may subsequently base their treatment decisions on the then current, i.e., altered, diagnosis contained within the data/information system, with profound implications to the patient's care. In like measure, data/information systems associated with other industries/applications have similar importance and influence on users, e.g., financial systems, accounting systems, billing systems, design systems, inventory systems, control systems, registration/enrollment systems, etc. In view of the significant implications associated with new, amended, revised, updated and/or deleted data/information within a data/information system, it is extremely important, inter alia, that each data/information transaction be clearly, reliably and accurately identified with the source of such transaction, e.g., the user who committed/inputted the transaction.

Of note, the source of a “transaction” need not be a human being because, for example, in automated control systems, “transactions” are frequently predicated on electronic and/or mechanical systems/sensors. For example, in a nuclear power plant, sensors generally feed data into a central computation unit that determines whether the plant is operating within safety margins by evaluating changes relative to a model of the entire state of the plant. If the model is given erroneous data by one or more sensors, then the safety and operation of the plant can be compromised. Each sensor can be said to be the source of transactions for purposes of the data/information system associated with the power plant, committing/inputting transactions into the model and the safety algorithm. The reliability and accuracy of such data/information input is critical, and the ability to subsequently identify the nature and source(s) of data/information delivered to the system is also of substantial importance.

Prior art versioning systems have been developed, e.g., in the word processing realm. According to such systems, it is generally possible to track changes made to documents, revert to earlier versions of documents, and determine the individual(s) involved in creating, modifying and/or editing documents. Certain commercially available database storage systems provide users the ability to revert to the database as it existed at a prior point in time. However, prior art versioning systems suffer from significant shortcomings in their ability to regenerate and display prior versions of files/records where ancillary changes have occurred within the system, e.g., changes to operating programs, changes to indices and files that are required to regenerate the prior file/record, and the like.

Indeed, FIG. 4 shows the problem when external (reference) information is not correctly versioned. The Symptom with ID 1 was entered at the time that the reference table “Code” had an entry with ID2 reading “Pulse.” At a subsequent time, the “Code” table was changed to make a distinction between Active and Resting Pulse. Because it was improperly versioned, this change affected the reproducibility of the earlier finding. The finding of a Pulse of 80/min., which could have been either an active pulse or a resting pulse, is now described definitively as a resting pulse.

Ideally, the recreation of files and records must take into account the inter-relationships between data items, the chain of responsibility for authorship of new or changed data, and facilities used for formulating retrievals, presenting the result of retrievals, and accepting new or changed data. Thus, improved data storage methods and systems are required to address such shortcomings and to provide improved functionalities with respect to storing, controlling and providing access to files and records.

### SUMMARY OF THE DISCLOSURE

According to the present disclosure, a system and method for improved data and/or information storage, control and/or access are provided. The system/method of the present disclosure facilitates enhanced versioning of data files, data records, information, and the like, such that subsequent data file and/or record retrieval is consistent with and reflective of ancillary conditions at the time of the data file and/or record input. Ancillary conditions include but are not limited to the inter-relationships between data items, the chain of responsibility for authorship of new or changed data, and facilities used for formulating retrievals, presenting the result of retrievals, and accepting new or changed data. The system/method of the present disclosure provides enhanced data/information storage, control and access having applicability in a variety of fields, including applications related to health care, mental health care, financial and accounting systems, industrial control systems, and the like.

### BRIEF DESCRIPTION OF THE DRAWINGS

So that those of ordinary skill in the art to which the subject disclosure pertains will more readily understand how to make and use the system and method described herein, aspects of preferred embodiments of the present disclosure will be described in detail with reference to the drawings, wherein:

FIG. 1 is a schematic view showing interaction between a user and an exemplary delivery vehicle associated with an information system according to the present disclosure;

FIG. 2 is a schematic view of aspects of an exemplary data architecture according to the present disclosure;

FIG. 3 is a schematic view showing exemplary definitional terminology according to an embodiment of the present disclosure;

FIG. 4 is a schematic view illustrating issues encountered using prior art systems and methods, i.e., in the absence of a system and/or method according to the present disclosure;

FIG. 5 is a further schematic view illustrating issues encountered using prior art systems and methods;

FIG. 6 is a schematic view illustrating an information system or decision-support system that uses versioning for primary data according to the present disclosure, but does not utilize versioning for reference data, traceability data, or external references;

FIG. 7 is a schematic view illustrating an exemplary embodiment of the present disclosure, wherein a decision-support information system uses baseline versioning to version primary data, reference data, traceability data, and external resources;

FIGS. 7A-7P provide schematic views illustrating aspects of exemplary embodiments of the present disclosure;

FIGS. 8-29 are exemplary screen shots according to an exemplary embodiment of the present disclosure, such screen shots illustrating an Electronic Patient Record (EPR) system for the field of behavioral health;

FIGS. 8-22 show an exemplary sequence of steps a user might take in creating a note version containing, in this example, a single statement, according to the present disclosure;

FIGS. 23 and 24 illustrate the visibility of information to other system users at several steps in the process, according to an exemplary embodiment of the present disclosure; and

FIGS. 25-29 illustrate how, in an exemplary embodiment of the present disclosure, the user interface and the behavior of the application are controlled by metadata provided to the system rather than through traditional software.

### DETAILED DESCRIPTION OF PREFERRED EMBODIMENT(S)

According to the present disclosure, a system and method for improved data and/or information storage, control and/or access are provided. The system/method of the present disclosure facilitates enhanced versioning of data files, data records, information, and the like, such that subsequent data file and/or record retrieval is consistent with and reflective of ancillary conditions at the time of the data file and/or record input. The system/method of the present disclosure provides enhanced data/information storage, control and access having applicability in a variety of fields, including applications related to health care, mental health care, financial and accounting systems, industrial control systems, and the like.

To create an ideal data/information storage system, it is essential to ensure reliability of the data/information contained therein, to provide versioning to facilitate recreation of and/or reversion to data/information as it existed at a prior point in time, and to ensure accountability with respect to the creation, entry, modification and/or deletion of data/information contained within the data/information storage system. According to the present disclosure, a data/information management system is provided that achieves and/or effectively addresses each of these objectives/requirements.

In providing an advantageous data/information storage system according to the present disclosure, it has been recognized according to the present disclosure that the system should advantageously effectuate irrepudiability as to transactions, i.e., data/file creation, entry, modification and/or deletion, so that responsibility for changes to the data state can be linked to the producers, i.e., individuals initiating the subject entries/changes/deletions. Irrepudiability according to the present disclosure leads to the requirements that:

1. All changes to the data state are mediated by transactions; no ad-hoc change is possible;

2. All transactions are themselves unmodifiable; and

3. All transactions identify their producers

By storing the contents of every transaction within a certain time-window (e.g., three months, seven years, forever, etc.), the data/file storage system is able to reconstruct changes to the state of the system at any point in time, identify which transaction(s) caused a particular state to be achieved, and identify the producer(s) responsible for those transaction(s). In particular, in a “Versioned Information System” according to the present disclosure, the present state of the data/file storage system is a reflection of all transactions committed up to the present time, applied in sequence, and any prior state of the system can be reconstructed by applying all transactions commited up to and including the time of the reconstructed prior state.

As noted hereinabove, the general concepts of “transaction-based systems” and “versioning” are utilized/offered to some degree in prior art systems, with transaction-oriented database systems and document-centric version control systems available from vendors such as Microsoft Corporation (Seattle, Wash.). However, the system/method of the present disclosure provides enhanced functionalities and capabilities that significantly advance the art, and reflect a deeper analysis and understanding of the practical implications of data/file storage, control and access.

For example, it is often equally important in assessing a data/file record to understand the nature of the data/information that was omitted and/or deleted from such record by one or more transactions as it is to understand the data/information present in the data/file record. It is also frequently important to understand the context under which the data/information was supplied to the data storage system. For example, in a healthcare setting, a transaction which purports to supply results from a clinician's comprehensive physical exam could report nothing about “shortness of breath.” A practitioner subsequently attending the patient, seeing shortness of breath preceding a cardiac event, might question why no notation was made of this symptom (or similar discrepancy/issue). In connection with a subsequent inquiry, several possible explanations might arise and/or be investigated:

1. The clinician may have simply been in error about the lack of presence of the symptom.

2. The clinician may have measured, observed or been told of the symptom, but neglected to have included it in the transaction.

3. All or part of the exam might have been conducted by a third party, and conveyed in an inexact or ambiguous form to the clinician, e.g., orally or through handwritten notes. Inexact or ambiguous scenarios could also include situations involving a patient's willful or accidental omission when self-describing his/her symptoms, either in a prompted or unprompted format.

4. The clinician may have supplied the information in some form (e.g., orally, written notes, email) to a third party proxy (e.g., clerical worker) for entering into the data/information storage system, and the error may have been caused by the third party proxy failing to accurately and unambiguously represent/enter it into the system.

In the context of an electronic information system, information about the record is always presented to the user (consumer) through a third-party intermediary, i.e., the system itself. And acceptance of input from a producer is likewise always through the system acting as an intermediary on behalf of the producer. Thus, there are other explanations that may exist or be worthy of investigation associated with the system, as opposed to or in combination with the third party proxy. In the following points, it is assumed that data/information is provided to the user (as consumer) by the data/file storage system as retrievals (e.g. on-screen or printed reports, or transmitted data) and accepted from the user (as producer) as “transactions” (e.g. filled-in form(s) or transmitted data):

5. A report used in the clinician's decision-making process could have been incorrect. For example, if there was a prior indication of “shortness of breath,” the clinician may not have chosen (or been obligated) to repeat mention of it.

However, if that symptom were from a different episode of care, but erroneously reported as coming from the current episode of care, it would have affected treatment.

6. The entry form may have allowed the producer to select a symptom from a table of common symptoms, and “shortness of breath” may have in fact been correctly chosen. However, between the time the transaction was committed and the time the nurse saw and/or reviewed the chart, the table could have been modified within the system in such a way that the reference to “shortness of breath” changed to a different symptom. For example, if the chosen symptom is stored by its index positioning in the database table, and a symptom with an earlier position is removed and/or a new one added, the index will no longer correctly refer to the desired symptom, i.e., “shortness of breath.”

7. The clinician or his/her proxy may not have been able to locate the proper entry form or section where the symptom was to have been entered.

8. The form(s) might not have included a place/location to enter the information in question, or might have presented it illegibly (e.g., white text on a white background).

9. The data/information may have been entered correctly, but a flaw in the information system may have failed to properly incorporate it into the transaction.

10. System failure or error could also apply to a non-human producer of a transaction. For example, a sensor could be reporting measurements by sending information coded in an agreed-upon standard and/or unit, e.g., Fahrenheit temperature. If the sensor and/or information system is modified such that one emits (or the other accepts) Celsius temperature, transactions containing correct data can be rendered erroneous by the time they are committed to the data store.

The system/method of the present disclosure incorporates a number of different and separable techniques, i.e., independently operable techniques/features/functionalities, to mitigate against all these types of errors/failures and, in the event an error/failure or apparent error/failure has occurred, to help determine the cause and associated responsibility. In particular, a system/method for recreating, to an increased and improved degree, the entire environment in which data/information was reported and/or solicited and/or accepted is provided according to the present disclosure. The system/method of the present disclosure allows users to address questions relevant to assessing, understanding, verifying and tracking data/information within the system, such as:

a) What means to retrieve information/data were available to the decision-maker and his/her/its proxies?

b) What means to accept new or changed information/data were present for the decision-maker and his/her/its proxies?

c) In what form was the baseline information/data presented to the decision-maker and his/her/its proxies?

e) In what form was the new or changed information/data accepted from the decision-maker and his/her/its proxies and conveyed to the data/information system?

d) How did the information system respond to the new or changed information/data conveyed to it?

f) Were there any translations, conversions, or aggregations of the new or changed information/data before it was incorporated into the baseline state?

The enhanced features and functionalities associated with the present disclosure are achieved through a system/method characterized, at least in part, in the following ways:

1. A preferred system/method according to the present disclosure provides an ability to incorporate “meta-information” into a transaction that establishes a chain of responsibility for the presentation of information to a decision-maker, the acquisition of information from the decision-maker, and/or the entry, coding, translation, conversion, and aggregation of information into a transaction. Any or all of these steps/functionalities may be performed by a human or a non-human machine or mechanism, and the chain of responsibility according to the present disclosure accommodates each such case.

2. A preferred system/method according to the present disclosure provides for the immutability (except for controlled maintenance operations) of information once a transaction has been committed.

3. A preferred system/method according to the present disclosure provides for the ability to recreate the information system's environment at the point in time when the transaction was created/entered/input.

Thus, according to preferred embodiments of the present disclosure, any means available for retrieval of prior data/information, and any means available to solicit, collect and/or input data that were available to the decision-maker, are capable of precise reconstruction. This functionality requires reconstruction both of the underlying data/information and the “infrastructure” that translated that data/information into accessible views. The infrastructure may consist of software codes and reference data (e.g., lookup tables), as well as resources, such as fonts, colors, formats and the like. In some circumstances, it can also be defined to identify the exact set of hardware (workstations, network cards, network cables, communications links) which were used for and/or associated with the subject transaction.

Architecture of Preferred Systems According to the Present Disclosure

Preferred systems according to the present disclosure provide an integrated software platform for data/information systems. A preferred application of the disclosed data storage/management system relates to a mental health information system. However, the disclosed data storage/management system (and associated methods) are not limited to mental health information systems, as described herein and as will be readily apparent to persons of skill in the art. Indeed, the disclosed system(s)/method(s) extend to essentially any and all data storage/management systems and preferably encompass all the operational and administrative needs of such applications. In the case of mental health information systems, for example, the disclosed data storage/management system advantageously encompasses the entirety of a mental health facility's clinical and administrative needs.

As contemplated herein, preferred system architectures according to the present disclosure advantageously address the following objectives. However, it is to be understood that advantageous and innovative systems may be provided that offer less than all of the following functionalities according to the present disclosure, and the disclosed system(s)/method(s) are not to be restricted and/or limited to system(s)/method(s) that necessarily achieve/address all of the stated functionalities. Preferred functionalities/capabilities include:

1. The ability to flexibly and cost-efficiently track changes associated with the operational system, e.g., the entity's clinical practice in the case of a mental health institution (e.g., changes in available types of medication, treatment approach, diagnosis, etc.) and including the facilities providing access and modification capabilities supporting the clinical practice;

2. The ability to flexibly and accurately track changes over time in a particular operational area, e.g., a patient's history (e.g., changes in the patient's medical history and treatment, diagnosis, demographic changes, etc.);

3. The ability to maintain a versioned, immutable, long-term (multi-year) storage and retrieval store for operational data, e.g., patient and related clinical data;

4. The ability to capture and retain the data in a normalized, structured form so that it can be used by a variety of automated tools to provide additional capabilities, e.g., clinical, administrative, and analytical capabilities;

5. Present the user with an easy to use, and intuitive interface that ultimately will support access from multiple devices using multiple modes of communication;

6. Become the user's portal to ancillary information systems, providing as many of the above capabilities as can be accommodated;

7. Provide an integrated platform for organizing and supporting all relevant enterprise-wide information system requirements within any operational (e.g., clinical) setting.

8. Provide tools that manipulate the structured data for desired purposes, e.g., improving patient care; supporting data analysis aimed at creating better modes of treatment and/or improving organizational effectiveness; improving clinician training, etc.

9. Provide effective security and privacy of all operational data, e.g., medical records.

For illustrative purposes, a set of design principles associated with preferred mental health data systems are described herein below. While the disclosed design principles are described with reference to a mental health data system, it should be understood and appreciated by persons skilled in the art that the design principles discussed herein apply with equal force, and by natural extension, to a host of alternative applications. Design principles associated with mental health information system(s) according to the present disclosure include:

1. A system that is based on a set of self-describing, structured medical vocabularies that represent clinical concepts, which are used to capture useful data about patients and their treatment. These medical vocabularies store most of the semantic structure of the mental health information system. The goal of this approach to managing semantic content is to allow the mental health information system to rapidly adapt to new and changed medical states by easily and efficiently modifying an existing vocabulary or importing a new/updated vocabulary. In mental health information systems according to the present disclosure, medical knowledge resides in data, not in the structure of the mental health information system application.

2. All data in the mental health information system is versioned and, once versioned, is immutable other than for controlled maintenance operations. Version-control and immutability are the sine qua non of providing an effective, reliable system associated with medical records. A “Versioning Manager” provides this service by preventing illegal mutations to the data; preferably this logic is provided at a point as close as possible to the data storage mechanism (e.g. the database).

3. User interface development is preferably “code-less”. That is, screens, reports, or other facilities for data retrieval and entry are generated from a description language that specifies content (including data access) and layout, rather than being programmed via a traditional graphical user interface (“UI”) library. By adopting a code-less UI development approach, systems according to the present disclosure may advantageously shorten development intervals and make it easier for new applications and features to be created and implemented. The degree to which a code-less approach is implemented may vary according to the present disclosure, e.g., the approach may involve pre-defining regions of the user interface using traditional software methods and then using a code-less approach to fill in the pre-defined regions to using an entirely code-less approach.

4. The application screens are themselves dynamically generated at runtime by a “Presentation Manager”. By generating screens dynamically, a mental health information system according to the present disclosure can more readily handle the combinations of data that characterize any particular patient record, and can more flexibly respond to changes in the underlying medical vocabularies.

5. Data access is mediated by a “Data Manager”, which manages the connection to, retrieval from and updates to the database. The Data Manager centralizes access to the data, providing local, per-user, caching of data and lazy evaluation of user requests. The Data Manager also ensures consistency of data across changes made during a user session.

6. The database is at the heart of mental health information system(s) designed and operated according to the present disclosure. The database holds patient information, as well as the structured medical vocabularies and the application metadata, which controls the generation of screens and manages access to data. Rather than acting as a dumb data store, the database is an active part of the application and encapsulates much of the business logic of the disclosed mental health information system via a series of views, triggers and stored procedures.

7. The application is preferably “bootstrapped” to, rather than directly installed on, individual client machines. By bootstrapping the application, changes can be immediately propagated to client machines without the potential expense and delay inherent in distributing software directly to each individual client. The database may also advantageously hold the application code, and provide that the same versioning mechanism used for the data will be used for the code, ensuring synchronization between code and data. This includes the code constituting components such as a presentation manager and data access manager, such that the facilities for retrieving data, presenting it, and accepting new or changed data, are versioned along with the data itself.

Information systems according to the present disclosure are preferably metadata controlled, event-driven applications built on a relational database. The application logic largely resides in the metadata and the database views and triggers. The disclosed information systems are generally presented to the user through a delivery vehicle that is an abstract engine for interpreting and “executing” metadata, but that directly implements only a scant portion of the application semantics. Instead, the delivery vehicle knows how to retrieve, read and execute the behavior implicit in the metadata.

For example, queries to extract or update data in the database are generally not defined in the delivery vehicle. Instead, queries and how to interpret their return values are preferably embedded in the data access metadata. Rather than defining the query itself, the delivery vehicle knows how to find and read the metadata that defines a data source and, from that metadata, the system knows how to set up queries and associate internal data structures to hold the results of the query. Similarly, access control is generally not a function of the delivery vehicle code. Instead, metadata controls what data is visible, what data is editable, etc. As a result, the delivery vehicle has very limited knowledge of the logic of the application according to the present disclosure. Rather, the delivery vehicle generally enforces the rules defined by the metadata, e.g. which queries to formulate based on security policy and user activity, how to present the results, how to accept new or changed data from the user, and how to convey it to the datastore. Aside from a few limited application-specific capabilities, the delivery architecture according to the present disclosure is generally ignorant of the behavior of the application.

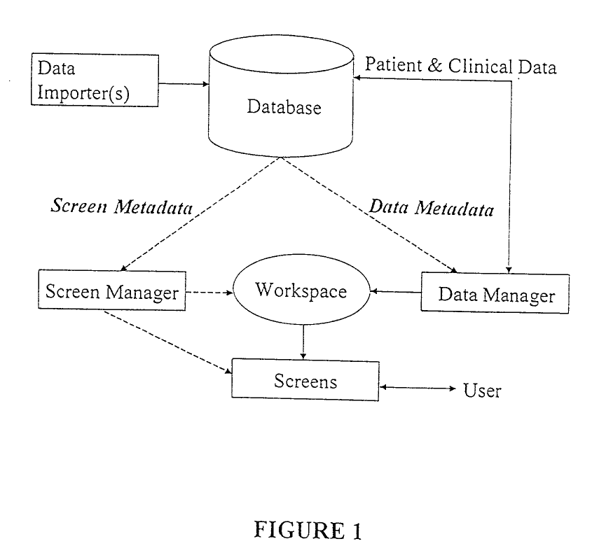

In preferred embodiments of the present disclosure, the delivery vehicle consists of a Screen Manager and a Data Manager, both of which are abstract engines controlled by their associated metadata. FIG. 1 provides a schematic view of a user's interaction with an exemplary delivery vehicle according to the present disclosure. At runtime, the user interacts with a set of dynamically generated screens that contain views of data that are fetched/retrieved from the database or entered by the user. The workspace holds an up-to-date copy of the data that is being accessed during the current session. The data in the workspace is created and updated in response to user actions. Data from the workspace is kept synchronized with the database, so that the view the user has of the data and the persistent state of the data is consistent.

Data importers may initially bootstrap a mental health information system according to the present disclosure, populating the database with a set of clinical reference data and the metadata that controls operations of the disclosed mental health information system. Once the mental health information system is operational, these importers may be run periodically to upgrade the reference data, to add new capabilities or to modify existing behavior.

With further reference to FIG. 1, screens are created at runtime by the Screen Manager from screen metadata that is imported to and stored in the database. The screen metadata generally describes both the layout and content of the screens. In response to user actions, the Screen Manager creates an appropriate display and binds it to data structures in the workspace. The screen metadata generally includes information necessary to build these display-related data structures and provides the name(s) of the associated data source metadata. The Screen Manager passes requests for data to the Data Manager, which uses the data source names to fetch/retrieve the appropriate data source metadata. The Data Manager then uses the data source metadata to construct appropriate query objects and query caches to fulfill the request. The query objects fetch/retrieve operating and reference data in response to user interactions and the query caches hold the data returned by the database. The Data Manager binds the workspace data structures to the appropriate query cache, thus populating the data structures in the workspace with data fetched from the database.

Of note, operation of the Data Manager is significantly enhanced by two optimizations used to minimize the flow of data from the database. First, the Data Manager maintains caches that prevent duplicate trips to the database for data that has already been retrieved. Second, the Data Manager does its queries lazily, i.e., it requests data only when the front-end is ready to display the results. The caching strategy requires careful synchronization between the state of the cache and updates to the database proper. When the user executes a “save” action, the Data Manager ensures that data in the workspace that was updated or entered by the user is saved back to the database. Similarly, when the user declines to save changes, the cache is advantageously flushed to clean out any temporary changes that are not being made permanent by the user.

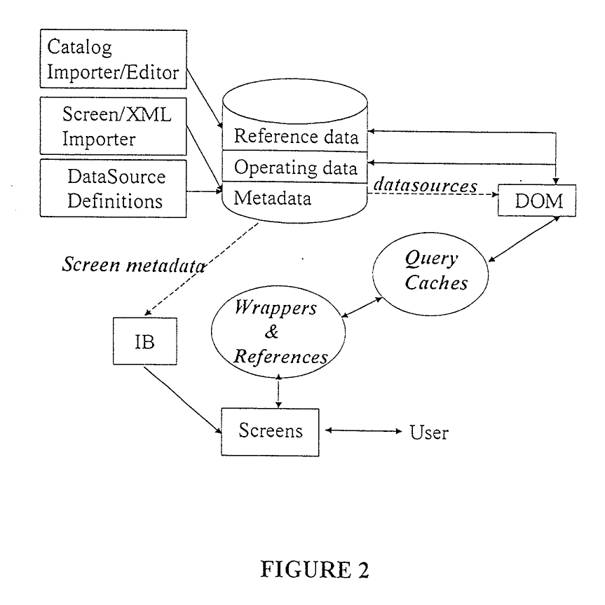

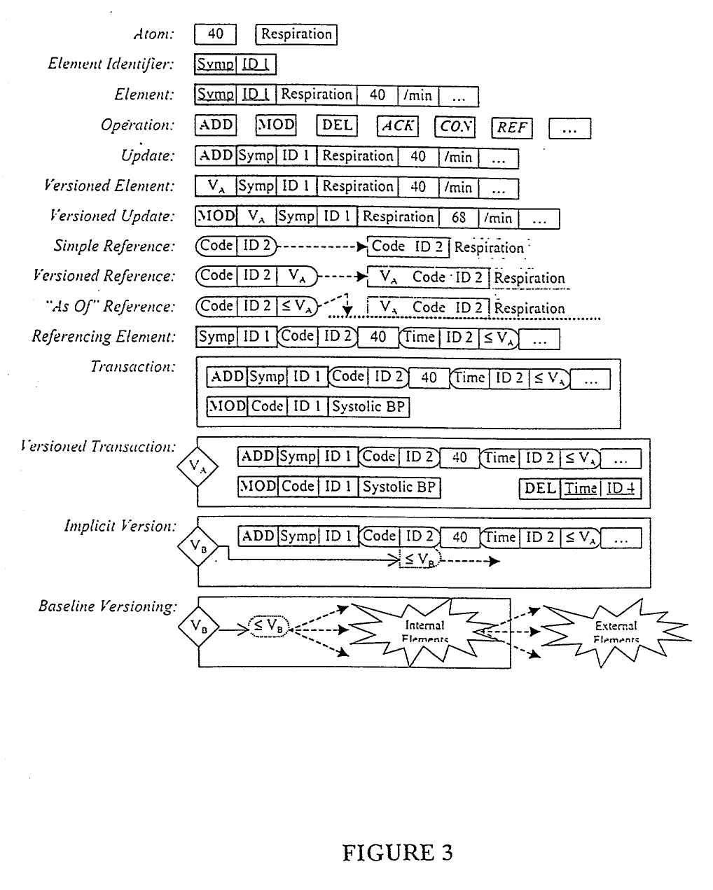

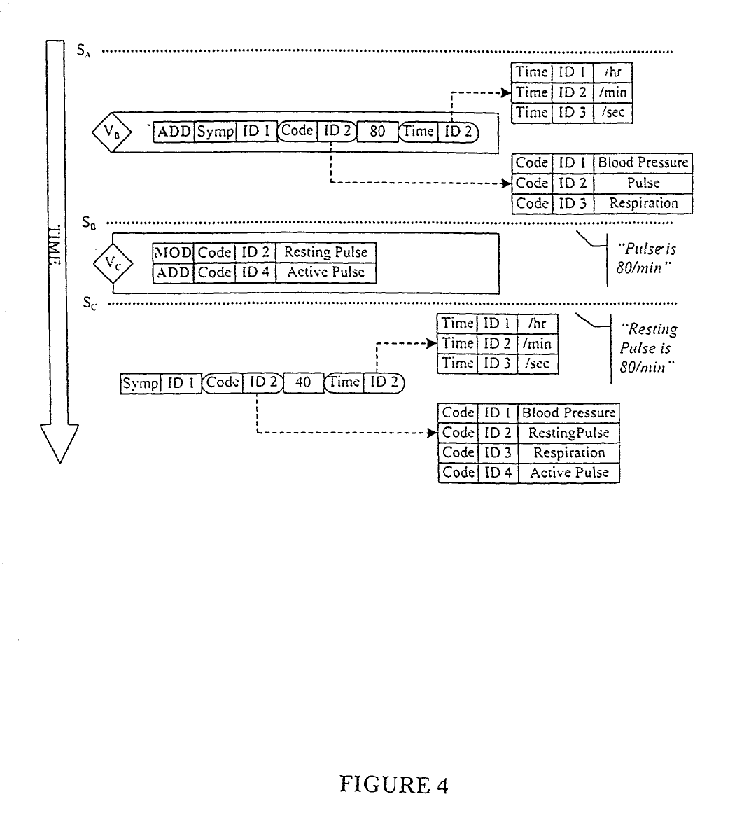

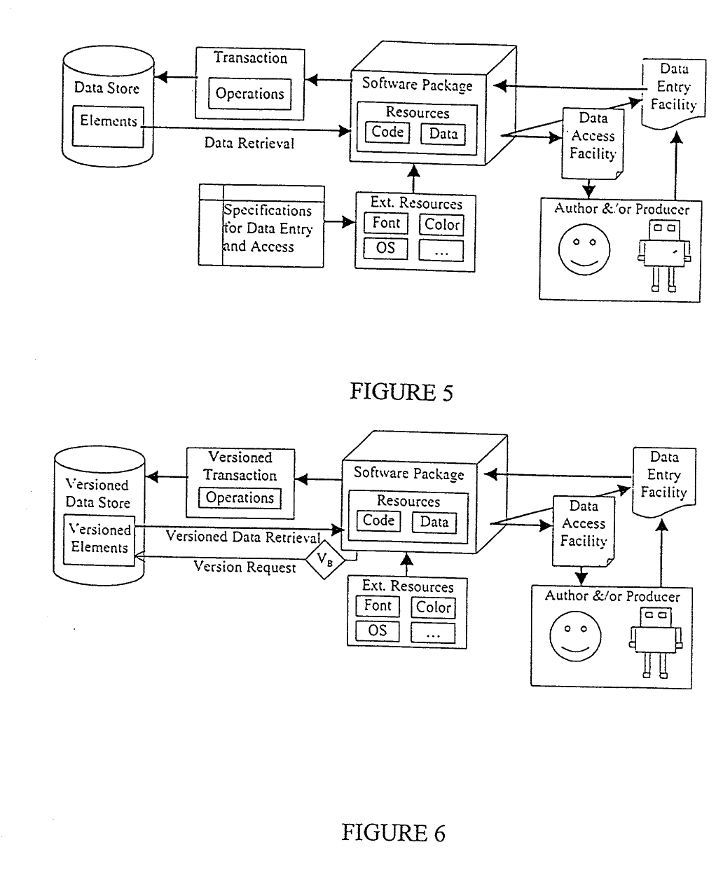

Turning to preferred data architectures and with reference to FIG. 2 (which schematically depicts exemplary aspects of a preferred data architecture according to the present disclosure), there are generally three kinds of data in a mental health information system according to the present disclosure: operating data, reference data, and metadata. Operating data (defined more fully below) is data about patients and is captured during day to day operational use of the mental health information system. Operating data generally consists of textual, temporal, or numerical values, and also references to the structured medical vocabularies, called reference data. Reference data includes clinical concepts related to the field of mental health. Operating data is entered by users and, according to standard mental health information systems, may be expected to change frequently in response to treatment of the patient. Reference data and metadata are more static, changing at periodic intervals. Reference data and metadata may be advantageously imported by data importers. Operating data are generally created as side-effects of the operations of the users of the mental health information system.

A fundamental advantage associated with information management systems according to the present disclosure, including particularly mental health information systems, is the definition of structured, normalized forms in which to capture operational data, e.g., information about patient treatment. By defining a structured vocabulary for recording mental health clinical concepts, the disclosed mental health information system is able to provide automated tools to capture, manipulate and analyze the data. The structured vocabularies provide reference data for the mental health information system and are generally stored in catalogs.

Each catalog defines elements related to a particular clinical domain. For example, there is a catalog corresponding to diagnoses, another that defines various drugs, etc. Catalogs contain entries that correspond to specific entities in these clinical domains. For example, the drug catalog may advantageously contain entries for each specific drug, e.g. an entry for valium, an entry for Prozac® (Eli Lilly and Company), etc. Catalog entries may, optionally, be further described through one or more specifiers that define the attributes of the catalog entry. Accordingly, a drug may be further defined by specifiers that define the dosage, frequency, how the drug is administered, etc.

Catalogs are produced from a variety of source inputs. Some of these inputs conform to well-recognized standards, such as the DSM definitions for clinical diagnoses that are defined in the Fourth Edition of the Diagnostic and Statistical Manual with Text Revisions (DSM-IV-TR) as published by the American Psychiatric Association and from which the field of Behavioral Health draws it diagnoses in the United States as well as in many other countries. Others are widely used, although they constitute only informal standards, such as the Multum database of drugs. Still others have been uniquely created according to the present disclosure to capture common clinical concepts that are not otherwise standardized, such as concepts related to treatment planning. Not surprisingly, data from such disparate sources comes in disparate forms. However, in mental health information systems according to the present disclosure, each of these catalogs is stored in a normalized form. Catalog importers are written for each source of data to translate them into the desired canonical form for the disclosed mental health information system(s).

Catalogs serve at least three purposes in mental health information systems according to the present disclosure: (i) forming choices from which the clinician may select entries to describe an interaction with a patient, (ii) catalog entries become references within the disclosed mental health information system that constitute the bulk of the operating data therewithin, and (iii) catalog entries specify constraints for business rules, such as selectability, persistence, and access control. Catalog contents are thus generally central to the behavior of mental health information systems according to the present disclosure.

Each catalog entry typically includes specification(s) that control how the entry is displayed to the user. These controls include both visual aspects, such as what kind of widget is used to display the data, as well as semantic aspects, such as the list of additional specifiers that the user is presented to choose from to refine a selection. Thus, defining the reference data in large part defines the behavior of the overall mental health information system, i.e., what the user sees and how he/she sees it.

Also of central importance to the operation of information management systems according to the present disclosure are two types of metadata associated therewith:

1) Screen metadata, which describes the contents and behavior of each screen; and

2) Data source metadata, which describes the queries that may be used to access, and data types returned by, various database views.

Metadata is generally defined in files in the XML programming language, and the XML is imported into the database by an XML Metadata Importer. This metadata is read by an Interface Builder (IB), which is part of the front-end of the delivery vehicle as schematically depicted in FIG. 2. The IB uses the screen metadata to create a tree of Java Swing components, bound to data from the database, that will implement the screen as specified in the metadata. The screen metadata also provides the data requests(s) needed to obtain reference or operating data that will be displayed on the screen. The IB passes the data requests(s) to the Data Manager and binds the data components on the screen to the resulting structures created by the Data Manager.

The foregoing data source metadata controls the runtime behavior of the Data Manager, thereby forming the back-end of the delivery vehicle. The data sources describe abstract queries that the Data Manager instantiates and executes when data is requested by the front-end. The data sources also describe the return types that these queries produce so that the front-end can present the results.

Exemplary delivery vehicle architectures according to the present disclosure entail instantiation within an abstract delivery vehicle runtime environment that knows how to interpret and execute particular metadata. The delivery vehicle itself is bootstrapped, rather than being installed, on each client machine.

The nature and characteristics of the data elements collected, stored and retrieved, as well as the design and operation of the associated database(s), according to the present disclosure are now described. In connection therewith, definitions for certain terms used in describing such data and databases in the context of a mental health information system are set forth herein below. Appropriate corresponding definitions for such terms in the context of information systems for use in alternative applications/industries according to the present disclosure will be readily apparent to persons of skill in the relevant fields.

“Operating Data” is usually related to patient care, and may be added, modified and removed in the daily activities of either users or the mental health information system itself. For example, clinical operating data includes patient charts, episodes of care, clinical notes, diagnoses, etc. Non-clinical items such as addresses, event schedules, bills, bed inventories, etc., are also operating data, since they can change in the course of day-to-day activities.

“Reference Data” is data used that is not expected to change during day-to-day activities, and is most often defined as part of a catalog of data of functionally related information. Examples of reference data are industry defined data-sets of pharmaceutical information, diagnostic code numbers, sets of government issued identity numbers for persons and physical locations, etc. Reference data is typically used to interpret fields within operating data—thus it is referenced by operating data. While a body of reference data, called a catalog, can be created in the mental health information system, and new entries added over time, such as when a new pharmaceutical comes into use, individual reference data items may not be physically overwritten or deleted according to the present disclosure. A pharmaceutical withdrawn from use, for example, is not physically deleted from the mental health information system, though it may be suppressed from current treatment planning. Were that not the case, then the interpretation of operating data that had used such pharmaceutical data in the past, and that references it, for example, would fail or change post-facto, which is unacceptable in a clinical system.

“Immutable Data” is data that, once added, cannot be modified or removed in any way.

“Non-Versioned Data” is data that can change by being overwritten or deleted, in which case the prior state of the data will be lost.

“Versioned Data” is data in which changes are grouped into transactions containing one or more discrete actions, each of which supplants the prior state with new or replacement data, without modifying the preexisting data.

“Field” is a scalar value which is stored somewhere, and can subsequently be retrieved at a later time. A field is typically mapped to a column of a row (i.e., cell) of a database table. A field may be mutable or immutable, depending on the context in which it is presented, including the identity and ensuing authority of the person to whom it is being presented, where it is being presented, and other factors. This set of factors is referred to as the “mutability rule” for the field, and must be specified.

“Element” is composed of a set of related “attribute” (defined below) values. Elements roughly correspond to rows in a database view or instances in an Object Oriented (O-O) programming language.

“Element Class” defines the “attributes” (defined below) and behavior for one or more elements. For example, Webster's Dictionary defines a class as “a group, set, or kind sharing common attributes.” The class defines which attributes the member elements will support, and the elements define the values of those attributes. Thus, an element class can be thought of corresponding to a view in a database, or a class in an O-O programming language.

“Variant classes” provide all of the attributes and behavior of their parent class, with additional “attributes” (defined below) and/or variant behavior.

“Attribute” is defined by Webster's Dictionary as “an inherent characteristic; also an accidental quality,” and “a word ascribing a quality.” That is to say, an attribute is a question you can ask about something. Asking the question of that thing returns as a response a “value” for the attribute. Attribute values are not necessarily atomic. Like a field, a mutability rule must be defined for every attribute. There are two subtypes of attribute, depending on how the value to be returned is derived.

“Direct Attribute” is an attribute composed of one or more fields. If all of the fields composing a direct attribute are mutable, then the attribute is potentially mutable, and will be mutable without specific instructions to the contrary. However, an attribute associated with an immutable field is immutable.

“Computed Attribute” is an attribute whose value is calculated as a function of one or more other attribute values. Computed attributes are not generally mutable unless provision is made for inverting the computation or inference.

The following Table 1 shows exemplary “attributes” of a hypothetical element class. The direct attribute GivenName is associated with a field of the same name, while the inferred attribute FullName is the result of a computation involving several other attributes.

TABLE 1

| Attribute | | | |
|---|---|---|---|
| Name | Type | Construction | M* |
| GivenName | String | Field ‘GivenName’ | ‡ |
| FamilyName | String | Field ‘FamilyName’ | ‡ |
| Prefix | ID | Field ‘Prefix,’ referencing an | ‡ |
| | | element (in catalog of all prefixes) | |
| PrefixLabel | Computed | Field ‘Label’ from the catalog element | No |
| | String | referred to by attribute PrefixLabel | |
| FullName | Computed | Attribute PrefixLabel followed by | No |
| | String | GivenName followed by FamilyName. | |
| StartDate | FuzzyDate | Fields ‘StartDate’ and ‘StartPrecision’ | ‡ |
| EndDate | FuzzyDate | Fields ‘EndDate’ and ‘EndPrecision’ | ‡ |
| Duration | Computed | Difference between EndDate | No |
| | | and StartDate | |

M* column indicates whether the attribute is mutable or not. For the entries marked ‘‡’, the answer depends on whether the underlying field(s) that formed the construction are mutable.

Attributes can be grouped into several discrete categories based on the roles they play for an element. Attribute role groups include context attributes, versioning attributes, variable attributes, fixed attributes, and terminating attributes. Versioning attributes are further broken down into the identifier and the version key. These attributes are all described below.

“Context Attributes” determine where the element can be found. (It does not make sense to say “is located,” because something can be found in many places, but it is not necessarily located in many places.) Reference data may not need context attributes, but operating data does, since operating data provides a traversal path (e.g., patient→chart→episode of care→note, or note→episode of care→chart→patient) by which it can be found.

“Versioning Attributes” reflect the fact that all operating data, and most reference data, can be operated on/changed at some point over its lifetime. In some cases, those changes can be accomplished by directly modifying stored data; however, in the large majority of cases, it is done by “versioning”, i.e., creating an element which is to be substituted for some initial target element, without in any way modifying the target element. A sequence of “versioning actions” is applied to the target element. Some of these actions are associated with replacement elements that provide a different changed set of values, while other actions declare the nonexistence (in some context) of the target element. However, references to the target element will be unchanged. At some point in time, the initial target element exists alone. At some later point in time, it and a replacement element exist. At some later point in time, the replacement element may be a target for a second replacement element, and so forth. The initial element and the chain of actions and replacement elements are called versions, which taken together are referred to as a single “versioned element”.

Two primary relationships may thus be inferred from the foregoing discussion according to the disclosed systems/methods:

1. There must be a way to relate all versions of a versioned element to each other. The set of attributes of an element class that allow this relation may be referred to as the identity key of the class. The values of each identity attribute, when taken together, form an identity value that uniquely defines the identity of each of the versioned elements of the class, i.e., the set of versions comprising it. Of note, the identity value for some target element(s) cannot be changed without both destroying its identity and severing the relationship between it and the substitute elements associated with it; identity attributes are thus tautologically immutable.

2. There must be a temporal (or at least sequential) ordering between the initial element and all the substitute elements that have been applied to it. The set of attributes of an element class which define this sequential relationship of the versions may be referred to as the “version key” of the class, and the values of those taken together may be referred to as a “version value”. For similar reasons as discussed with reference to identity attributes, a version value is also tautologically immutable. Version values must be unique within each versioned element (initial element with all substitutes), but are not necessarily unique across different versioned elements, even of the same class.

Additionally, there are a number of secondary relationships that can be inferred from the foregoing “versioning” discussion and the two primary relationships described hereinabove:

3. Anything that has an implied ordering can be used as the version value. For example, an incrementing integer, the date that an initial or substitute element was created, or a reference to some other sequenced set of elements, may be utilized. Specifically for clinical data, an episode of care (“EOC”) contains a set of notes, each of which has a date-stamp that orders them into a sequence; thus a reference to a note can be used as the version value for multiple versioned elements, with the limitation that there can only be one substitute element (version) per versioned element per note.

4. The initial version of a versioned element is the version with the lowest version value.

5. The current version of a versioned element is the version with the highest version value.

6. Given a version value between the lowest and highest possible values, the value of the versioned element can be determined “as of” that particular version. The value is considered pre-existent for version values below the version value of the initial version.

Finally, it should be noted that there can be several versioning streams associated with an element class according to the present disclosure. A “versioning stream” is some information which can be inferred from a version value, which indicates whether the associated version is or is not considered part of some contextually-defined set of versions for the versioned element. In this way, each version stream can be considered to supply an independent set of changes, while all sharing the same versioning attribute set.

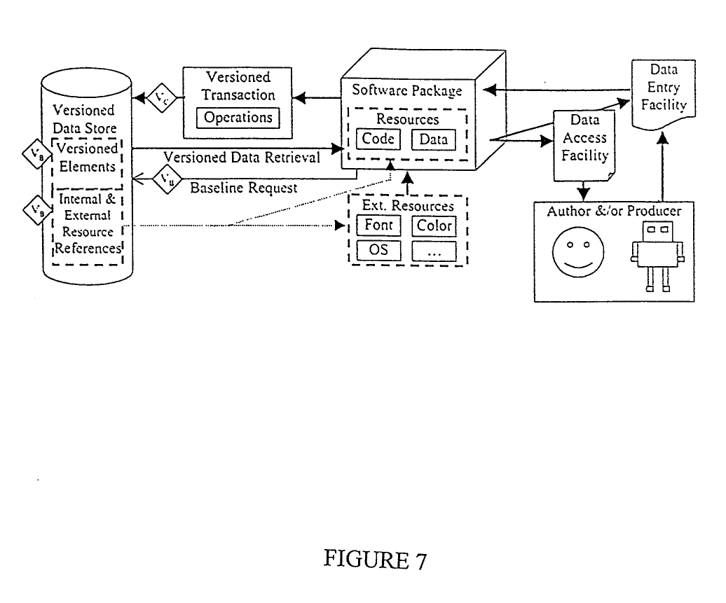

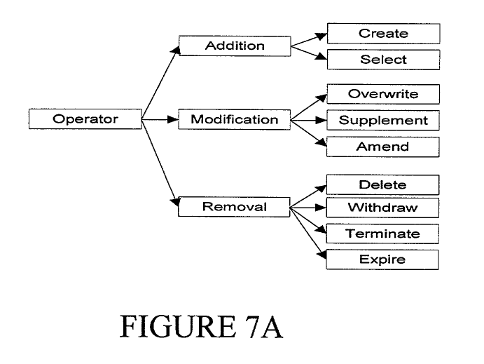

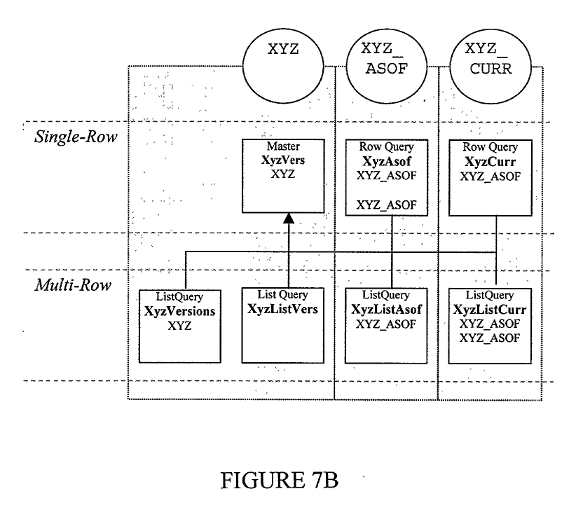

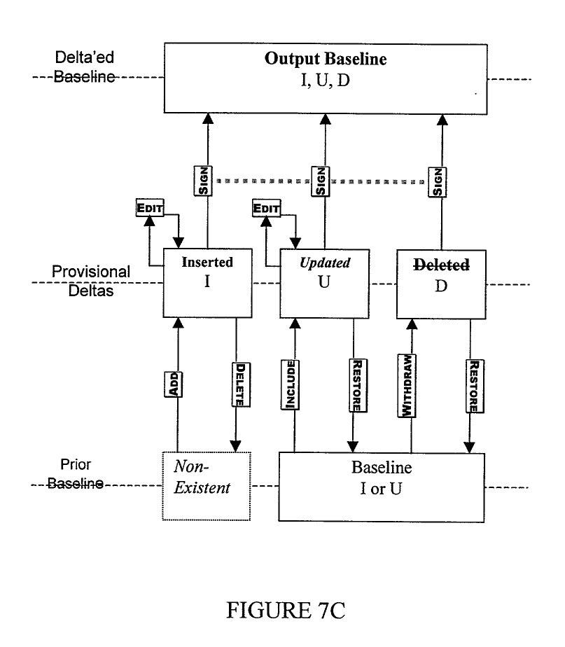

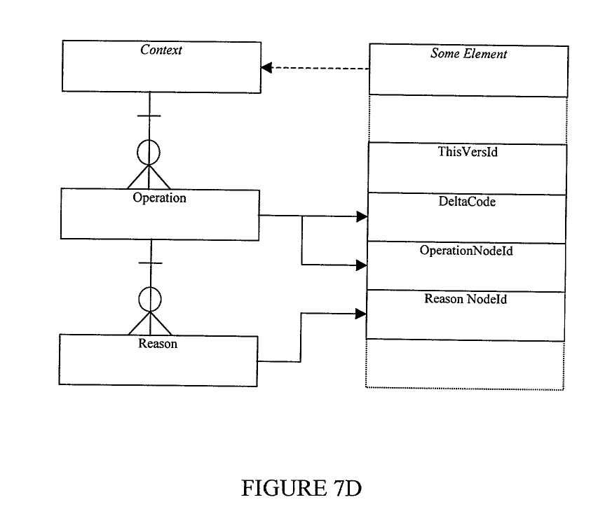

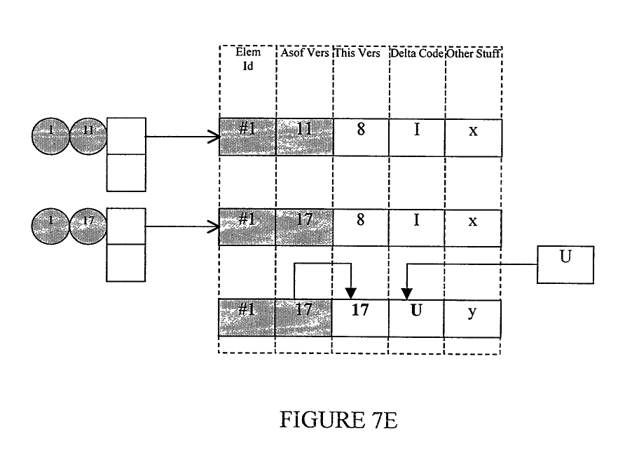

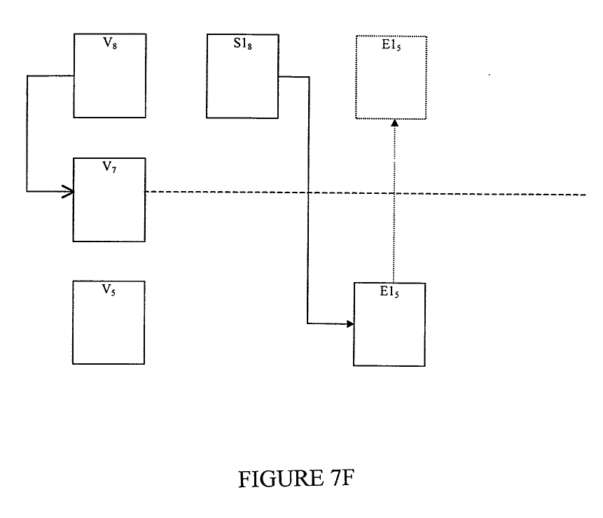

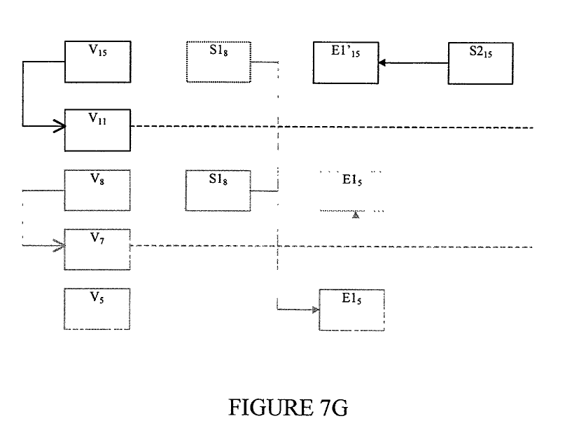

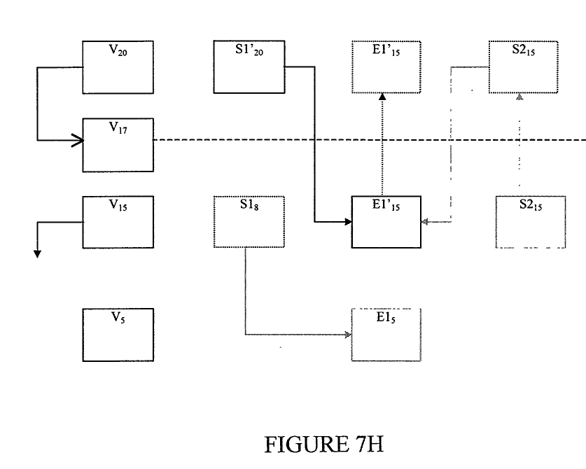

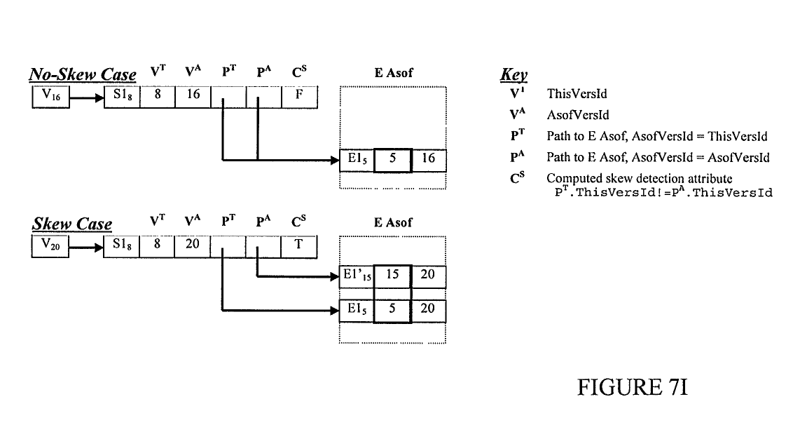

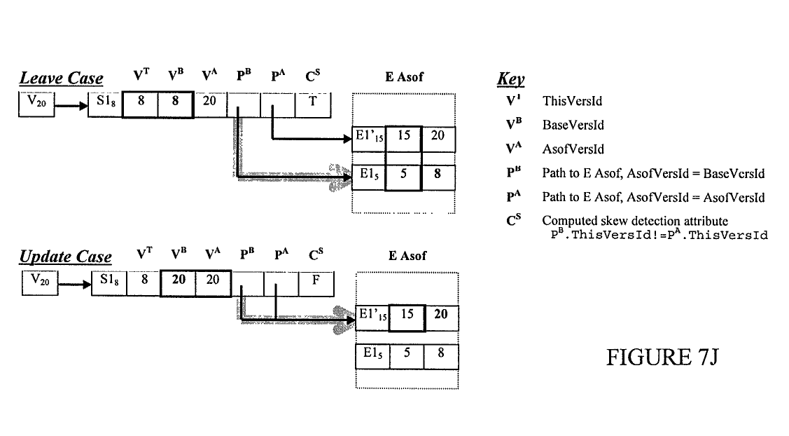

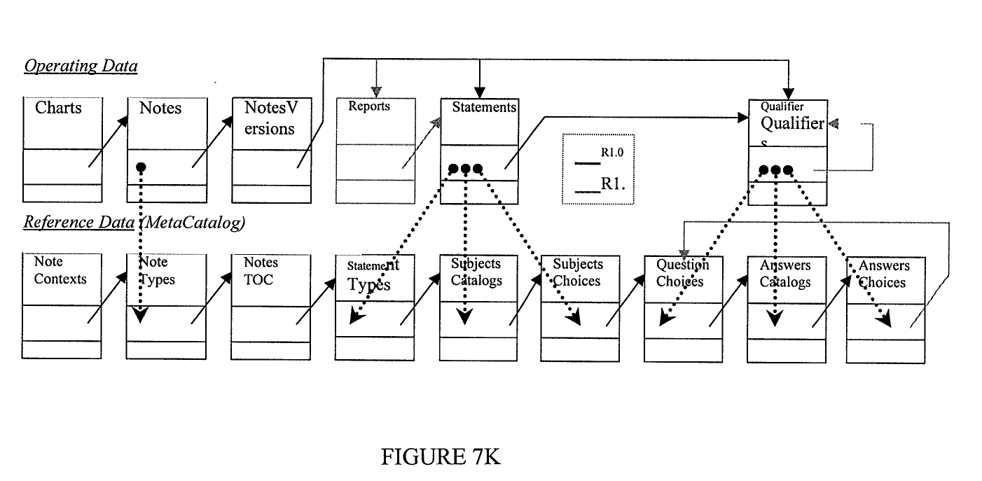

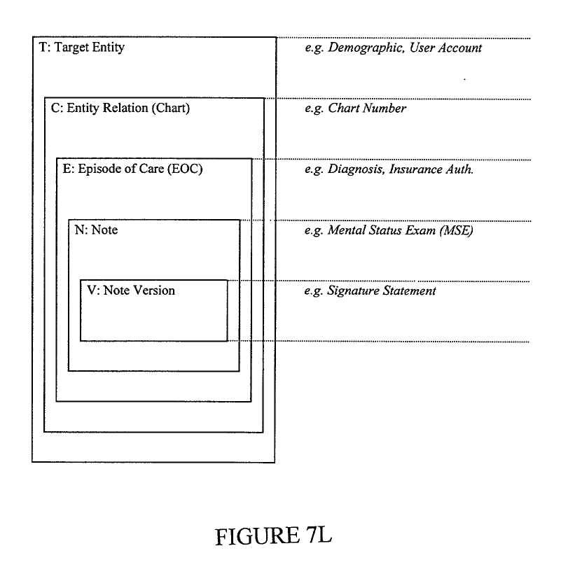

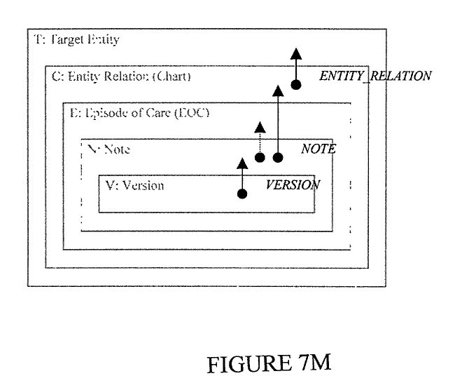

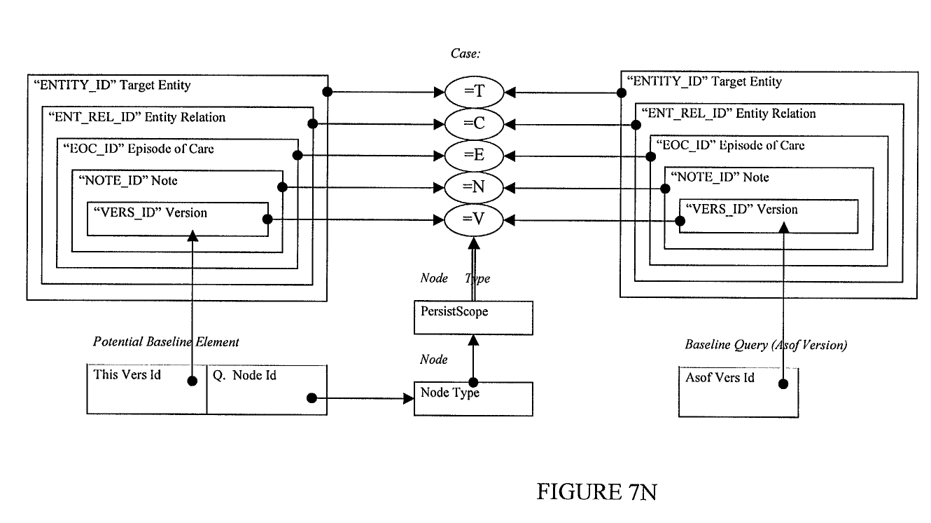

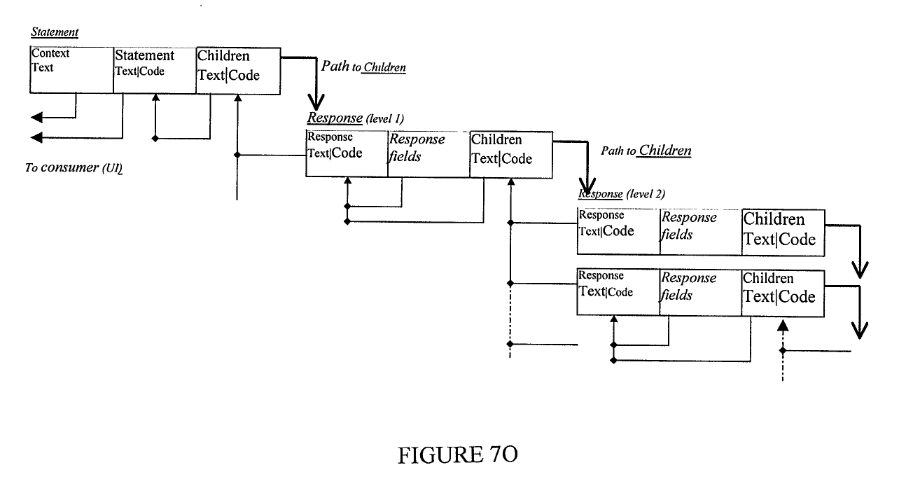

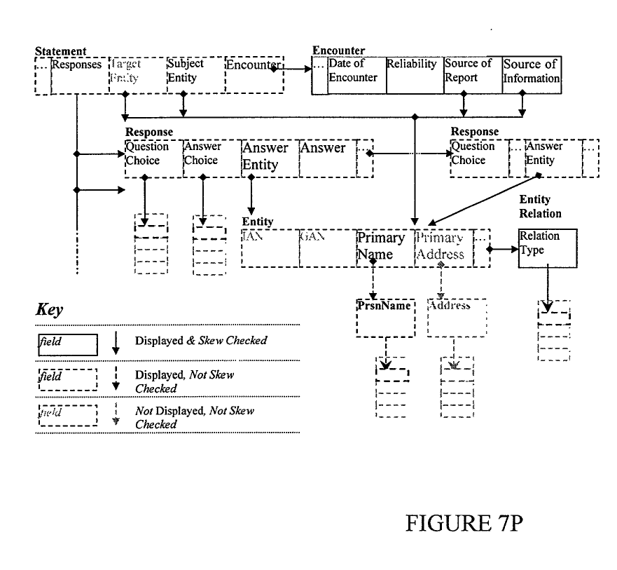

“Action” applied to data elements is used to indicate any of a number of different events which each introduce change in specific ways. Action is further divided into a series of change actions, namely “addition”, “modification”, and “removal” actions. Each of these actions has a different effect on data. The taxonomy of actions according to the present disclosure is described below. Certain of these actions may be effectively and advantageously mapped directly to buttons, as schematically shown in FIG. 7A.

“Addition operations” either introduce or appear to introduce new elements into one or more version streams. There are two subtypes:

“Create” entails bringing a new element into existence and then attaching it (via its context attributes) to one or more containing or referring elements. An example would be to instantiate a diagnosis, and link it to the note that contains it, the person it refers to, etc.

“Select” or “Reference” entails introducing references to elements found in one version stream into a different version stream. For example, Axis IV diagnoses are selected from the list of current precipitating factors, stressors, and traumas for the subject (patient).

“Modification operations” either alter data or produce the appearance of altered data in one or more version streams. There are generally three subtypes:

“Overwrite” entails modifying an element in such a way that the prior state no longer exists. In preferred embodiments of the disclosed mental health information system, it is only possible to overwrite elements contained in an uncommitted version. Once the version has been committed, the elements within it become immutable.

“Supplement” entails providing an element that updates a prior element with a new one regarding the same subject. The prior version is considered true as of the time it was made, and the supplemented version is also considered true as of the time the supplementary element was brought into existence. As noted above, a statement and its supplements constitute a versioning stream.

“Amend” entails providing an element that replaces a prior element with a new one regarding the same subject. It is differentiated from a supplement in that some part of the prior state is considered incorrect. In some cases (based on the class of element), a reason code may be required. One or more versioning streams can exist based on the different reason codes.

“Removal operations” either destroy data or produce the appearance of destroyed data in one or more version streams. There are generally four subtypes according to the present disclosure:

“Delete” entails taking an element completely out of existence, in such a way that its prior state cannot be recovered. In preferred embodiments of the disclosed mental health information system, it is only possible to delete elements contained in an uncommitted version. Once a version has been committed, withdrawal and termination are the only ways to explicitly remove elements contained therein.

“Withdraw” indicates that an element which had been brought into existence in the past is retroactively considered to be false or inaccurate as of the time it was created. Withdrawal typically requires that a reason code be provided that will generally indicate, inter alia, whether the assertion, authoring, or entry clauses were at fault. The reason code may be used as a flag to suppress (withdraw) the element from one or more versioning streams it participates in. Withdrawal of an element typically will prevent reintroducing it at a later time.

“Terminate” relates to the fact that an element that continues over time can be terminated to indicate it no longer continues or holds true. Terminate differs from withdrawal in that the element is not indicated as false or inapplicable at any point in time prior to the termination. For example, a problem can be terminated once it has been shown to be in remission; withdrawal would indicate that it never had been a problem. In most cases, a reason code is required, based on the class of element; the reason code typically flags which versioning streams the element has been terminated in. Depending on the class of element, it may be possible to reintroduce (reactivate) terminated elements with a subsequent amendment.

“Expire” relates to the fact that an element that continues over time may have a time-limit or other rule that causes it to automatically expire. Depending on the class of element, it may be possible to reintroduce the element after expiry. For example, most modal treatments (such as a prescription) will have a built-in time limit; after this limit has been exceeded, the modal treatments will be expired unless an amendment to continue (renew) has been filed.

Any of these versioning operations “Elevates” a baseline element into the editing Version, setting the ThisVersId field to the Note Version's ThisVersId and the DeltaCode to a code based on the particular versioning operation, e.g. ‘X’ or ‘U’ or ‘D’ depending upon whether the element is being selected (cross-referenced) or updated (amended) or deleted (withdrawal, termination) in the elevated record. The elevated record shadows the baseline record in the editing Version and all subsequently created Versions.

“Restore” reverses the action of Elevation or Creation of an Element by removing an included record from the editing Version. For elevation, the baseline record is no longer shadowed; for creation, where there is no baseline record, the element no longer exists.

Turning to preferred data schema(s) according to the present disclosure, for purposes of embodiment in database Tables, every element “XXX” is generally split into a fixed part “XXX_FIX” providing the identity key XXX_ID and any immutable fields (values locked in at element creation time), and a variable part “XXX_VAR” with a foreign key reference XXX_ID to the fixed part, a foreign key reference THIS_VERS_ID to the field THIS_VERS_ID in the Version record (defined below) in which the variable part was created (from a delta operation on the element), and then element-specific data fields to hold time-varying data. The Version element also has a field BASE_VERS_ID providing the baseline for the version; according to preferred embodiments of the present disclosure, the BASE_VERS_ID is always initialized to the same value as THIS_VERS_ID and, in preferred systems/methods, does not change. Set forth below are a series of columnar presentations summarizing the foregoing discussion:

| | |
|---|---|
| XXX_FIX | A table holding the invariant part of |
| | versioned element XXX. |
| XXX_ID | Primary Key identifying which XXX |
| <other fields> | Immutable fields defined by object XXX |
| XXX_VAR | The variant part of the record representing |
| | versioned element XXX. |
| XXX_ID | Foreign Key to XXX_FIX.XXX_ID identifying |
| | which XXX, part of Primary Key |
| THIS_VERS_ID | Foreign Key to VERSION. VERS_ID. part of |
| | Primary Key |
| DELTA_CODE | The operation which occurred, ‘I’ (Insert), |
| | ‘U’ (Update), ‘D’ (Delete), ‘X’ (crossref) |
| REASON_NODE_{—} | FK to a catalog containing user-supplied reasons for |
| ID | the delta (not all elements will have this). |
| <other fields> | Mutable fields defined by object XXX |

A set of “views” provides an API (programming interface) for performing retrieval and modification operations on the database tables comprising an element XXX, as summarized in the following columnar presentation:

| | |
|---|---|
| XXX | A view joining the invariant XXX_FIX and mutable |
| | XXX_VAR records, with triggers |
| | to divvy up the fields to their respective tables |
| | and perform integrity checking |
| XXX_ASOF | A view on XXX providing at most one record per |
| | XXX_ID, chosen to be the record with the greatest |
| | publishing date that is less than the publishing |
| | date of the provided ASOF_VERS_ID |
| | and for which the DELTA_CODE is not |
| | ‘D’, or which is equal regardless of the publishing date, |
| | and which meets XXX-specific aging criteria. The set of |
| | records is generated via a cartesian join with all possible |
| | VERS_IDS, which is then collapsed by an externally |
| | provided clause “WHERE ASOF_VERS_ID = ???” |
| | to only the desired As Of records. If ASOF_VERS_ID |
| | is NULL, then the highest possible VERS_ID |
| | (e.g. 999999999) is used, providing a view of |
| | the baseline as of the current time. |

Turning to preferred database schema(s) according to the present disclosure, for an ASOF view, where a Version's Baseline Version ID is utilized to provide an As Of version ID, the underlying view typically performs a Cartesian join of every possible VersId with the latest version of the Statement as/of that Version, which is collapsed to a single row by the AsofVersId provided in the query.

In a preferred embodiment, a unique-row (element) caching scheme is utilized for the application's storage of “as of” retrieval results, with an “XyzVers” row (element) cache of the XYZ view and an Query “XyzAsof” row (element) cache attached to the XYZ_ASOF view. A separately cached rowlist is preferably provided for each AsofVersId query for a particular Xyz or list of Xyzs, so multiplied copies of the same element version do not result. This is accomplished by including AsofVersId as a query key in the As Of queries, but omitting it as a cache key in the element (row) cache—accordingly, it would appear in the WHERE clause but not the SELECT clause of the As Of query. This scheme is illustrated in FIG. 7B.

Versioning operations are typically performed by the application on the XXX_ASOF views accessed from within a particular Version. The behavior of certain operations changes based on whether any particular element in the XxxAsof has been created or updated in the Version. Based on the fact that selections are generally made from the XxxAsof view using the Version's ThisVersionId as the AsofVersionId, two possibilities generally arise which are calculated in the computed attributes shown:

| Criterion (in ElemDeltaTf) | Condition | Attribute |
|---|---|---|
| ThisVersId != AsofVersId | Baseline- | IsBaselineTf |
| | no delta in this Version | |
| ThisVersId == AsofVersId | Included- | IsIncludedTf |
| | a delta appears in this Version | |

Additional computed attributes reflect whether an Elevated element has been Inserted or Amended or Withdrawn:

| Criterion (in DeltaCode) | Condition | Attribute |
|---|---|---|
| DeltaCode == ‘I’ | Inserted | IsInsertedTf |
| DeltaCode == ‘X’ | Cross-Referenced (included | IsReferencedTf |
| | in version without | |
| | changes) | |
| DeltaCode == ‘U’ | Updated (e.g. Amended) | IsUpdatedTf |
| DeltaCode == ‘D’ | Deleted (e.g. Withdrawn) | IsDeletedTf |
| DeltaCode == ‘C’ | Conditionally Amended | N/A |
| (never returned by | (update only - turns to | |
| query) | U or X in the record | |
| | depending on whether | |
| | data values have | |
| | changed; used mainly | |
| | for catalog importer) | |

An Element is referred to as “Included” within a Note Version if there is a version of the Element corresponding to the Note Version. An element is referred to as “Elevated” if there is a corresponding Baseline Element with the same identity. Elevation can have a Delta Code of ‘X’, ‘U’, or ‘D’, while Inclusion adds to this set ‘I’ to accommodate newly-created Elements.

It is desirable to switch display of Elements, or to switch enabling of the controls which operate on them, based on the source of the Element, e.g., whether it is from the baseline or was included by another operation. A computed attribute ElevationCode in the element can advantageously evaluate this logic and return a one-letter code (‘B’, ‘I’, ‘X’, ‘U’, or ‘D’) allowing for a single test: InclusionCode:=IslncludedTf? DeltaCode: ‘B’. This sequence typically leads to/generates the following state-table indicating the behavior the user interface (“UI”) needs to implement:

| S | Condition | Display Style | Edit/Modify Operations | | Delete/Withdraw Operations | |
|---|---|---|---|---|---|---|
| B | Baseline | Plain | [symbol] | Insert Amendment | [symbol] | Insert Withdrawal |
| I | Inserted | Bold | [symbol] | Edit Insertion | [symbol] | Delete Insertion |
| X | Referenced | Underlined | [symbol] | Include in Version | [symbol] | Delete Includion |
| U | Amended | Italic | [symbol] | Include & Amend | [symbol] | Delete Amendment |
| D | Withdrawn | [symbol] | [symbol] | Include & Withdraw | [symbol] | Delete Withdrawal |

The state transition diagram illustrating the above-noted operations is schematically depicted in FIG. 7C.

The above-noted operations can be mapped directly to buttons according to the present disclosure. The following columns set forth the capabilities of the individual buttons:

| | |
|---|---|
| [symbol] | create a new Element record (set DeltaCode to ‘I’) |
| [symbol] | elevate an Element record (set DeltaCode to ‘U’) |
| | pop up editing pane for that Element |
| | [symbol] pop down editing pane, keeping modified Element |
| | [symbol] restore Element to prior state, pop down |
| | editing pane |
| [symbol] | elevate an Element record (set DeltaCode to ‘D’) |
| | pop up Element Withdrawal pane asking for confirmation |
| | and a reason choice |
| | [symbol] pop down withdrawal pane, keeping modified |
| | Element |
| | [symbol] restore Element to prior state, pop down |
| | withdrawal pane |
| [symbol] | pop up editing pane for that Element |
| | [symbol] pop down editing pane |
| | [symbol] restore Element to prior state, pop down pane |
| [symbol] | pop up Deletion Confirmation pane |
| | [symbol] pop down confirmation pane, delete record |
| | [symbol] pop down confirmation pane |
| [symbol] | pop up Deletion Confirmation pane |
| | [symbol] restore Element to baseline state, pop down |
| | confirmation pane |
| | [symbol] pop down confirmation pane |

The toolbar typically includes a [symbol] Button that functions as the OK button, storing the currently selected Catalog and Catalog Entry into the destination record and popping down the Catalog Entry Chooser. The [symbol] Button typcially pops down the Catalog Entry Chooser without changing the Catalog and Catalog Entry fields in the destination record.

The operator summary charts which appear below supplement the information described/depicted herein above and describe exemplary user interactions and related implementation of operators. They also describe the action taken on the element, and for reason code-based supplement/amend or withdraw/terminate decisions, how the various reason codes affect the modification log. A specific operator summary is typically provided for every class of clinical operating data. These examples of operator summary charts apply to three general classes of elements; however, these exemplary charts are for explanatory purposes only, and actual clinical modules may include additional and/or alternative details.

Axis I, II, or III diagnoses, treatments, etc. work with a system where added elements are created, unsigned elements can be edited or deleted, and signed elements can be amended or supplemented, or terminated or withdrawn, based on a reason code:

| Operator | Signature | User | | DB | Reason | Modification |
|---|---|---|---|---|---|---|
| Category | State | Command | User Interaction | Action | Group | Record Log |
| Add | N/A | [symbol] | Selector & Details | Create | * | Created |
| Modify | Unsigned | [symbol] | Details | Overwrite | * | N/A |
| | Signed | [symbol] | Details & Reason | Version | Mod 1 | Supplemented |
| | | | | | Mod 2 | Amended |
| Remove | Unsigned | [symbol] | Confirmation | Delete | * | N/A |
| | Signed | [symbol] | Reason | Version | Term 1 | Terminated |
| | | | | | Term 2 | Withdrawn |

Axis IV diagnoses are selected from the patient's current list of precipitating factors, stressors, and traumas when added, and deselected when removed; there is no modification allowed, since there is no information in the diagnosis not found in the underlying elements:

| Operator | Signature | User | | DB | Reason | Modification |
|---|---|---|---|---|---|---|
| Category | State | Command | User Interaction | Action | Group | Record Log |
| Add | N/A | [symbol] | Selector (PF/S/T list) | Select | * | Selected |
| Modify | N/A (unless severity etc. gets added) | | | | | |
| Remove | Unsigned | [symbol] | Confirmation | Deselect | * | N/A |
| | Signed | [symbol] | Reason | Deselect | Term 1 | Terminated |
| | | | | | Term 2 | Withdrawn |

The “Mod 1”, “Term 2”, etc. reason groups delineate a subset of elements from the element class-specific reason table; set forth below is an exemplary abbreviated subset from diagnosis:

Modification Reason Groups

| Group | | Reason | Applies To |
|---|---|---|---|
| Mod | 1 | Change in Patient State | Present |
| | | Cannot use current status in presence of | Present |
| | | substance use | |
| | | Cannot use current status in presence of | Present |
| | | medical condition | |
| | 2 | New information provided | Present, |
| | | | Historical |
| | | Entered in error | Present, |
| | | | Historical |
| Term | 1 | Does not meet diagnostic criteria at this time | Present |
| | | New symptomatology indicates another | Present |
| | | diagnosis | |
| | | Cannot diagnose in presence of substance | Present |
| | | use | |
| | | Cannot diagnose in presence of medical | Present |
| | | condition | |
| | 2 | New information provided renders diagnosis | Present, ? |
| | | inapplicable | |
| | | Entered in error | Present, |
| | | | Historical |

According to the present disclosure, there are many potential purposes for and/or reasons to elevate an Element, leading to a larger set of choices a human might wish to make to describe the operation being performed, nonetheless reducing to the same three versioning operations described heretofore:

Referencing

Referencing, Citing, Incorporating, etc.

Affirming, Reaffirming

Renewing, Reinstating, Continuing

Modification

Correcting, Clarifying (e.g., values were inaccurate)

Updating, Titrating (e.g., situation has changed)

Deletion

Revoking, withdrawing (e.g., original was not accurate)

Terminating, Stopping (e.g., should no longer continue)

It is also desirable according to the present disclosure to provide a distinction between both the class of operation (e.g., Inclusion vs. Modification) and finer distinctions as to the purpose. This can achieved according to the disclosed method(s)/system(s) with the addition of two fields:

| | | |
|---|---|---|
| Operation | Mandatory | This is the verb, e.g. Renewed, Corrected, |
| | | Revoked, chosen from a catalog of predefined |
| | | operations relevant to the context |
| Reason | Optional | This is further information on why the |
| | | operation was performed, either chosen |
| | | from a sub-catalog of predefined reasons |
| | | coded to the selected operation, or |
| | | supplied by the user as free-form |
| | | textual input |

This gives the schema illustrated in FIG. 7D for the case where the Reason is selected from a catalog of predefined choices.

In connection with changes, the display generally would reflect the operation in both an Operation column and by way of Display Style, e.g., as illustrated herein below:

| Code | Statement | Operation & Reason | Date |
|---|---|---|---|
| 121.21 | Silly Walk syndrome, | ! Amended due to | Oct. 08, 2000 |
| | Moderate | Change in Condition | |
| [symbol] | [symbol] | - Revoked due to | Oct. 02, 2000 |
| | [symbol] | Revised Information | |
| 543.21 | Backwards Counting | Sustained due to | Oct. 02, 2000 |
| | Syndrome | Unchanging Condition | |
| 11.11 | Snake Eyes syndrome, | Added | Oct. 08, 2000 |
| | Double | | |
| 444.X | Bad mood syndrome, | ! Revised due to | Oct. 08, 2000 |
| | Mild | Revised Information | |

The style mapping disclosed herein can be implemented/handled with the HTML text field in a number of ways. The simplest approach is to add fields to the DeltaCode table, providing the start and end tags for each type of delta. Alternatively, one can map the version delta codes into elements with a naming structure, e.g., ‘op?’ (where ? is the versioning delta code) and use a Cascading Style Sheet to transform these tags into HTML attributes, e.g.:

<STYLE TYPE=“text/css”>

opB {font-style: normal}

opI {font-style: bold}

opU {font-style: italic}

opD {text-decoration: line-through}

opX {text-decoration: underline}

</STYLE>

The following columnar table shows a column with the human-readable translation of the operation, giving either an explicit translation of the delta code or a catalog of Operation Codes, and further columns indicating which operation controls should be enabled:

| DeltaCode | Condition | HtmlStartTag | HtmlEndTag | AmendEnb | WithdrawEnb |
|---|---|---|---|---|---|
| B | Baseline | | | T | T |
| I | Added | <B> | </B> | F | F |
| X | Referenced | <U> | </U> | F | F |
| U | Modified | <I> | </I> | T | F |
| D | Withdrawn | <S> | </S> | F | T |

An Element HTML string can then be rendered by surrounding the element's text with the appropriate start and end tags, using either of the aforementioned means to determine said tags.

The user interface thus visually reflects the shadowing of baseline Element records by delta records, and provides appropriate operations to elevate a baseline Element record into a delta record and restore a delta record back to the baseline record. There are several distinct means in which to achieve these objectives, e.g.:

Elevate could create a new Elevated record for an Element by cloning and patching the Baseline record, and for Restore delete the Elevated record. Under this strategy there needs to be a way to multiplex (switch), for any particular Element, between displaying the Elevated record if it exists and the Baseline record otherwise. An advantage to this approach is that several versions could share the same Baseline record, and all operations would occur in the data cache. A potential disadvantage is that the multiplexing functionality could add an undesirable level of complexity.

Alternately, a single record for each Element could be created, and the system would switch it between Baseline and Elevated state on Elevate and Restore. If the data cache uses the AsofVersId field to be a key, then each queried Version would receive its own cached copy of the Element's Baseline or Elevated record, which it could then freely modify. Elevate would set ThisVersId to the Note Version's ThisVersId (i.e. to AsofVersId) and override the Baseline's Delta Code with ‘U’ or ‘D’; an Update trigger in the database would detect these occurrences and insert or update a VAR record for that ThisVersId. Restore could either delete the elevated record, or update it with a special DeltaCode, e.g., ‘R’, causing the trigger to delete the VAR record, and then requery the individual row to restore it from the Baseline; if it did not exist in the Baseline then no restored record would be returned. The points described in the paragraph are depicted in FIG. 7E.

Though in this latter case every Note Version brought into memory will have its own private copy of all Baseline records it references, the necessary memory utilization does not pose a problem. Each Note Version provides a private workspace, and Baseline records are, by definition, read-only (since they must come from a signed note), and therefore there is no problem with maintaining inter-Version synchrony within the application.

In both cases a database trigger on the XXX_ASOF view checks the AsofVersId, and DeltaCode and takes one of the following actions:

| | | Delta | |
|---|---|---|---|
| This VersId | Operation | Code | Trigger Action |
| != AsofVersId | UPDATE | N/A | Throw exception (Attempt to edit Baseline) |
| | INSERT | | |
| == AsofVersId | UPDATE | U | If VAR exists for AsofVersId |

If VAR's DeltaCode is ‘U’

Update the values with :NEW

Else

Throw Exception (Wrong state for Amend)

Else

Create a new VAR for AsofVersId with :NEW

| | |
|---|---|
| D | If VAR exists for AsofVersId |

Throw Exception (Wrong state for Withdraw)

Else

Create a new VAR for AsofVersId with :NEW

| | | | |
|---|---|---|---|
| | INSERT | I | Create new FIX/VAR pair from :NEW |
| | | other | Throw Exception (Illegal Insert DeltaCode) |
| N/A | DELETE | N/A | If VAR exists for AsofVersId |

Delete VAR
If no more VARs exist for this FIX

Delete FIX

Else

Throw Exception (Nothing to Delete)

After setting the code to R (or deleting the record) and flushing to the database, i.e., a restore operation, the UI must remove the old record from its cache and requery the record from the database.

According to the present disclosure, a phenomenon termed “version skew” may occur when a versioned element that refers to other versioned (and therefore editable) elements is elevated. For example, a Statement Element (defined subsequently) may refer to an Encounter and several Entities. Assuming an Encounter E1₅ in Version 5, and Statement S1₈ in Version 8, the reference from S1₈ to E1 is constructed via Asof views on S and E using V₈'s baseline V₇; bringing up E1₅, as the baseline version, as shown in FIG. 7F.

Adding S2 in V₁₅ (which has V₁₁ as its baseline), and at the same time making a correction (amendment) to E1 causes it to be elevated into V₁₅ and become E1′₁₅, as shown in FIG. 7G. Finally, in V₂₀ it may be desirable to amend S1, which involves elevating it into the current version as S1/₂₀. As soon as this is done, all of the references to other operating and reference data elements will switch to the versions accessible as the baseline of V₂₀, say V₁₇, as schematically depicted in FIG. 7H. As a result, the value of E1 has switched from E1₅ to E1′₁₅ without the user's explicit permission. This phenomenon may be termed “Version Skew”.

In some cases, version skew is not a problem. If an entity's address has changed between amending a Statement, there is no clinical significance. However, some references cannot be altered without explicit acknowledgement of the Version's Author. In a clinical information system, each reference must be examined to see whether the effect of version skew is significant. In the case when it is, this leads to two potential problems that are ideally addressed: Detecting such changes to referenced Elements, and controlling the response to detected change.

Version skew occurs when the version of a referenced data Element will change after the referencing Element is elevated. Based on the above discussion on Versioning Operations, it is apparent that elevation involves a change in ThisVersId from that of the Baseline Element to that of the Elevated Element, which will be that of the editing Note Version and reflected in the AsofVersId used to query the Element. Thus, it is only necessary to compare ThisVersId from the referenced elements using ThisVersId and AsofVersId of the referencing element, as shown in FIG. 71.

An element E will already have V^{T}, V^{A}, and a P^{A}_{N} paths for each referenced Element E_{N}; to do the skew detection, a P^{T}_{N} path is added for each referenced Element E_{N}; then a C^{S} expression attribute can OR all of the version comparisons together to reveal whether version skew has taken place. Of note, a referenced element may reference other elements and thus be subject to its own skew. The skew detection expression C^{S} can incorporate the version skew value of referenced elements by ORing them in along with skew detection for the elements themselves. It should do this from the PT fork (not PA). This leads to an expression of the form:

VersSkewTf = P^{T}₁.VersSkewTf || P^{T}₁.ThisVersId != P^{A}₁.ThisVersId
|| P^{T}₂.VersSkewTf || P^{T}₂.ThisVersId != P^{A}₂.ThisVersId
||...

In the above scheme, the value of C^{S} will always be correct, indicating potential skew with the current baseline of the Version. For example, if the Baseline is updated, C^{S} will change from FALSE to TRUE if the new baseline introduces changes to referenced elements. If it is TRUE and the Element is elevated, C^{S} will change to FALSE because the skew will already have occurred.

Based on the foregoing, there are several possible ways to alert the user of version skew according to the present disclosure:

Skew can be shown continuously by displaying an icon (or some other visual mapping) for the referencing Element whenever C^{S} is TRUE. This would alert the user both: (i) that the Element references out-of-date elements and should be considered for elevation; and (ii) that the Element will change in some referenced Element when elevated.

A warning can be presented at the time a Referencing Element is elevated for amendment that it will undergo Version Skew. This warning could include “before and after” renderings of the referenced elements, obtained by traversing P^{T}_{N} and P^{A}_{N}, respectively, to obtain the referenced elements for the rendering.

A warning can be posted before a Referenced Element is elevated for amendment that it will cause Version Skew in Referencing Elements. This can be shown by filtering the Referencing Elements such that only those referring to the Element being amended are shown. This approach generally requires analyzing every possible Referencing Element and creating the appropriate data sources and paths from the Referenced Element.

Notwithstanding the foregoing discussion, it may be desirable according to the present disclosure for a user to choose to accept the skew when elevating a Referencing Element for amendment. To accommodate such flexibility, a SkewVersId field may be added to the Referencing Element, or for the finest level of control, to the individual reference. This is initialized to the ThisVersId of the containing Version. The Referencing Element's (or reference's) SkewVersId is then used, rather than the Version's AsofVersId, when traversing a path to a Referenced Element's XxxAsof view. This path P^{B}_{N} replaces P^{T}_{N} in the Skew Detection scheme, i.e., is compared against P^{A}_{N}.

Thus, when elevating the Referencing Element, a system according to the present disclosure may offer a choice to the user:

If the Referencing Element's (or reference's) SkewVersId is left unaffected after the elevation, the system will continue to reference the older versions of any Referenced Elements and choice tables for selecting new values for the Referenced Elements.

If the Referencing Element's (or reference's) SkewVersId is bumped up to the current editing Version's ThisVersId during or after the elevation, the system will reference the newer versions of any Referenced Elements, e.g., up to and including the baseline of the editing Version.

This choice can be provided in a pre-Amend warning, e.g., #2 in the display scenarios. The different behavior between choosing [symbol] and [symbol] are shown in the schematic diagram of FIG. 7J.

Turning to additional aspects of preferred and exemplary mental health information system(s) and method(s) according to the present disclosure, certain terms and their usages herein associated with the collection and reporting of clinical information are set forth below. As will be readily apparent to persons skilled in other fields of endeavor, corresponding terms and usages may be utilized with respect to information systems and methods having applications in other fields and industries.

The User Interaction column generally refers to Selector, Details, Reason, and Confirmation, sub-panels associated with a class of statement. An important aspect of preferred mental health information systems according to the present disclosure is an ability to comprehensively, accurately, and accountably record information about a patient. All clinical information is recorded by means of a logical paradigm called a clinical statement. The definition of a clinical statement as used herein formalizes the common English definition of a statement:

statement \'stAt-m [symbol] nt\ n (ca. 1775) 1: something stated as a: a single declaration or remark: ASSERTION b: a report of facts or opinions. 2: the act or process of stating or presenting orally or on paper.

A “Statement” in the context of the present disclosure is, in a general sense, a means to represent past, future, or intended occurrences as well as their narrative and authoritative contexts. While capturing the contexts along with primary content has utility in many fields and industries, it is of tremendous significance in healthcare in general, and mental healthcare in particular, where narratives from patients, relatives, and other parties can be irrational, delusional, dissembling, falsely remembered, inaccurately recalled, etc.

The statement is a Versioned Element containing an Assertion and a Context clause. The Statement generally includes a SkewVersionId field to control for Version Skew. The view STATEMENT_ASOF provides Statements as of a particular AsofVersId, as normal. However, application access is via STATEMENT_SCOPED_ASOF which provides Persistence Scoping, as discussed hereinbelow. The following definitions are relevant to a statement, according to the present disclosure:

“Statement Type”: This is a reference to a MetaCatalog Node and is used to group a collection of Statements into logically related groups. Example: Diagnosis, Treatment, Identity.

“Subject Catalog”: This is a reference to a MetaCatalog Node and is used to retain the Catalog from which the Assertion (stored in Subject Entry) was chosen. The Catalog Group for Subject Catalog is a Has A descendent of the Statement Type for that Statement. Example: DSM-IV Axis III, Precipitating Factors Stressors and Traumas, etc.

“Subject Entry”: This is a reference to a MetaCatalog Node and is used to define the Assertion. The Catalog of choices for Subject Entry is a Has A descendent of the Subject Catalog for that Statement. Example: 302.1 Schizotypal Disorder, Birth of a child. The Node Type of the Subject Entry also determines the Persistence Rule for the Statement, i.e., the scope for which it persists in the Baseline of newly created Notes and Note Versions.

“Reference Entity”: This is the Entity on whose behalf the Statement was created. For example, a statement about a patient's parent exists on behalf of the patient, so the patient is the Reference Entity. This is always equal to the Reference Entity of the Note of the Note Version in which the Statement was created, but is denormalized for ease in selection, and in case we allow Notes with Statements about different Entities.

“Subject Entity”: This is the Entity which the assertion is about. It is chosen from the set of Entities who have some relation to the Reference Entity.

“Event Start” and “Event End” fuzzy date/times. Each of these is composed of a choice indicating the “fuzz” and a date/time value.

In the present disclosure, a Statement is represented as a collection of Versioned Elements that bundle together an assertion (what was said) with the context in which it was said, the context in which it was reported, and the subject to which it pertains. In exemplary mental health information systems and methods according to the present disclosure, the treatment of clinical statements is formalized according to the following clauses:

The occurrence clause—delineates a specification of what happened (or what will happen) to whom and when.

The assertion clause—delineates the source that brought the information to the author. An assertion generally corresponds to the thing that is being stated. It is chosen from a catalog of assertions selected to be appropriate to some context in the user interface, and/or entered as free-form text string.

The authoring clause—delineates who the person responsible for documenting the occurrence, when they were told of the occurrence by the observer, and how reliable they consider the observation to be

The entry clause—delineates the author of the statement or the delegate that recorded the observation.

The signature clause—a final declaration by the person of authority that the complete statement, as entered, is correct. This is provided by the note or update which contains the statement.

The change clause—a description of how and why the statement is different relative to the prior version.

Statement Orientation:

It is during an encounter with a patient or third party that anecdotal statements are often conveyed to a clinician, who assesses their reliability and records them as subjective statements. The clinician may formulate and record statements of his/her own to document any observations which were made; these objective statements are not assessed for reliability. Finally, actions performed on or by the disclosed system/method are transformed into derived statements that describe them.

Objective Data is information that is measured by the clinician or by other parties, or is determined directly by the clinician.

Subjective Data is information relating to a patient, provided by the patient or by other parties which can not be measured and were not or will not be directly observed by the clinician.

In formulating and recording statements, the statements may include “Qualifier(s),” i.e., entries that qualify the thing that is being stated, i.e., provides additional details. The qualifier can be in the form of a free-form text string, an ordinary or unitized number, a precise or “fuzzy” date and/or time, a reference to some Entity, or a selection from a hierarchical list of choices contained in one or more catalogs. In the case of a hierarchical list, the selected qualifier may elicit further qualifiers, each of which is generally answered in the same ways.

A Qualifier can combine two or more fields, for example, in the case of a fuzzy date or unitized number. In the case of hierarchical listing of Qualifier choices, the Node Type of a “question” may determine which form of “answer,” i.e., Qualifier, is to be used, how it is presented on the screen for editing (by naming a UI module), and how it is rendered for presentation in a tabular listing (by providing a format string). For a question involving a choice in the answer, the field AnswerCatId provides a reference to the Qualifier catalog—the MetaCatalog Node from which the collection of Qualifier choices was drawn, and the field AnswerChoiceId provides a reference to the chosen Qualifier Choice Node. The MetaCatalog Node referenced by QuestionChoiceId serves also as the catalog of Qualifier Catalogs which can be chosen. With these three items, the UI can reconstitute the complete process when an existing Qualifier is edited.

A group of Qualifiers are generally linked into an n-deep tree with a ParentId field. A Root Qualifier has a NULL ParentId, and is considered a child of the Statement it is connected to via its StatementId field. The MetaCatalog Node referenced by AnswerChoiceId in a parent Qualifier serves as a Catalog of questions for its children, and so forth. In an exemplary embodiment of the present disclosure, the Statement and all its linked Qualifiers are considered to be one Versioned Element, that is a change to one is a change to all.

In formulating and recording statements, the statements may also include a “Context,” i.e., information pertaining to the historical context referenced by one or more Assertions, including:

Who are the assertion(s) about? This is the “Subject Entity”, e.g., a friend or relative of a patient.

Who do the assertion(s) pertain to? This is the “Reference Entity”. This would be the patient, user, etc.

When did the assertion(s) take place? This is the “Event Date”, a pair of Fuzzy Dates determining the start and, optionally, end times.

Temporal Orientation:

The temporal orientation of a clinical statement determines whether the statement refers to a past, present or future event relative to when the statement is being authored. Statements describing occurrences in an active episode of care are considered prospective statements if they apply to the future, and present statements if they apply only to the moment in which they are made. Statements describing past occurrences are historical, but further classified into retrospective for statements that were made in the past, vs. retroactive for statements that are made in the present but concern the past.

Clinical Scenarios

The following table lists exemplary clinical scenarios and associates each with its own Statement Orientation and also a Temporal Orientation.

| | Statement | Temporal |
|---|---|---|
| Clinical Scenario | Orientation | Orientation |
| Report of a past precipitating factor | subjective | retrospective |
| by Pt. or 3^{rd}party | | |
| Report of a current symptom | subjective | prospective |
| by Pt or 3^{rd} party | | |
| MSE report of a sign or symptom | objective | present |
| by the clinician | | |
| Treatment entered into the | objective | prospective |
| treatment plan | | |

A clinician's work with a patient exists in the disclosed mental health information system in the form of clinical statements. The following example is used to illustrate how a series of encounters with a patient might be summarized orally by a clinician. It is followed by a deconstruction of the clinician's oral account. The sections that follow the deconstruction define the types of clauses which, when formed into statements, become the disclosed mental health information system's representation of the oral encounter information.

### EXAMPLE

On 10/2 my secretary W entered a note I wrote the day before, which I edited and then signed the following day. In an encounter that day with Pt. Y and his mother, Pt. Y said he suffered a bout of depression for a month. His mother indicated that a year ago, Y was treated with ECT and released. She also said Y's sister had been diagnosed with depression in 1996; from her description it sounded like Major Depressive Disorder. Her statements seemed reliable, his a bit less so because of his muted affect.

On 10/8 I dug up some old paper records for Y. It seems Dr. Z, in his note of 3/9, indicated that in a 3/8 encounter with Y, Y said he was depressed from December to March, and so Z made a Dx of Dysthymic Disorder (300.4). I agreed with his Dx, prescribed Wellbutrin for a month, and wrote it all up in an note for entry into the mental health information system, which I signed that day.”

Deconstruction of Clinician's Oral Account:

The example includes statements concerning two people (Pt. Y and Y's sister), made by four people (Pt. Y, Y's mom, Dr. X, and Dr. Z), clinically recorded by two people (Drs. X and Z), and entered into the system by two people (Dr. X and Sec'y. W), all signed by Dr. X. They concern two encounters (Y to Z, Y and Y's mother to X) and three episodes of care (an historical one for Pt. Y, an historical one for Y's sister, and an operational one for Y) written up in three notes (Z's paper note, and X's two RCE notes).

The disclosed mental health information system advantageously allows these statements to be entered, represented, presented, reported from a number of different standpoints (Pt. Y's lifetime history, all treatments provided to Y during an EOC, all times Dr. X prescribed Wellbutrin, etc.) and audited.

The occurrence clause is information describing the state of a person (such as Sx, Tx, Dx) that exists, existed, or will exist in a person's life. It is generally composed of three attributes.

Noun Phrase: A description of what happened, is happening or will happen. For example: symptom of depression. A noun phrase is often a construction of a set of Fields.

Subject: The person to whom the noun relates. For example, the above symptom of depression relates to the patient. It is possible that the subject of the occurrence clause can be someone other than a patient. For example, when a history of suicide relates to a patient's mother or wife.

Occurrence Date: When the occurrence is reported to have taken place or is planned. This could be a single date (an event) or a range of dates (an episode).

The following table is used to illustrate the type of information typically contained in an Occurrence Clause according to the present disclosure. It does not refer to specific data elements, attributes or fields.

| | Noun Phrase | | subject | Occurrence date |
|---|---|---|---|---|
| O1 | Sx | depression | Pt. Y | in January for a month |
| O2 | Dx | Major Depressive | Pt. Y's sister | in 1996 |
| | | Disorder | | |
| O3 | Tx | ECT | Pt. Y | a year ago |
| O4 | Tx | 150 mg Wellbutrin BID | Pt. Y | start 10/8, for 30 days |
| O5 | Sx | depression | Pt. Y | dec→mar |
| O6 | Dx | Dysthymic Disorder | Pt. Y | on Mar. 8, 1999 |

O1, O3, O5, and O6 are historical occurrences concerning the patient (Past Psych Hx).
O2 is an historical occurrence concerning someone with a psychological or genetic influence on the patient (Family Hx or Social Hx).
O4 is a current occurrence concerning the patient (Current Tx).

The assertion clause portion of a statement defines the person who reported the occurrence, the Source of Information—or SOI, and when the SOI informed the person of authority. The SOI is typically chosen from a list of possible sources. The list of possible SOIs for a particular patient generally includes: the patient, the clinician of record, the author of the statement, as well as a catalog of patient-specific choices which can include friends or relatives of the patient, or someone encountering the patient in a professional capacity, such as a police officer, ambulance driver, or the like. For objective statements, the SOI can be inferred as the author of the statement.

The assertion clause generally includes the following attributes:

Source of Information: Who provided the information, e.g., a reference to an Entity.

Statement Date: When the occurrence was reported to the responsible observer

Occurrence: A reference to the Occurrence Clause of the Statement.

The following table exemplifies aspects of entries that include an assertion clause:

| # | on | stmt date | I | source | Assertion | Occurrence |
|---|---|---|---|---|---|---|
| AS1 | on | Oct. 1, 1999 | I | Pt. Y | observed | O1 |
| AS2 | on | | I | Pt. Y's mother | observed | O2 |
| AS3 | on | | I | Pt. Y's mother | observed | O3 |
| AS4 | on | Oct. 8, 1999 | I | Dr. X | planned | O4 |
| AS5 | on | Mar. 9, 1999 | I | Pt. Y | observed | O5 |
| AS6 | on | Mar. 9, 1999 | I | Dr. Z | observed | O6 |

In the foregoing table, S1 and S5 are examples of the patient's subjective statements, S2 and S3 are a 3^{rd} party's subjective statements, S4 is Dr. X's objective statement, and S6 is Dr. Z's objective statement.

The authoring clause generally defines the person authorized to formally record data, when and where it was recorded, and a determination by the authorized person of the reliability of the statement as a whole. Subjective or narrative information of this type can only be recorded in the clinical record when accompanied by annotation by a person with clinical authority, describing the circumstances under which the statement was obtained and, given those circumstances, an assessment of its potential reliability. This is provided in the authorizing clause which accompanies subjective statements.

For a clinician using a mental health information system according to the present disclosure who directly hears accounts from sources, or directly performs operational activities, the recorder is the clinician. For example, “On [date] I heard the Pt. say [occurrence].” However, if an old medical record is transcribed, it is the person that wrote that record who did the recording (since it is under that person's clinical authority); therefore, it is that person's statement and its date of recording that is used. “In her note of [date] Dr. Y wrote that on [date] he heard the Pt. say [occurrence].”

To every statement, this approach to information collection and recordation only adds a few new attributes:

Person of Authority: Who recorded the statement in a clinical context.

Reliability of Statement: This is a judgment of the veracity of the statement, either on a per-statement or per-SOI basis.

Date of Recording: This is the date that the statement was made to the recorder.

An encounter can be considered as a rendezvous between the person making the statement and the person recording it, so for anecdotal statements, it is the date of the encounter.

Where Recorded: This is the real (paper) or virtual (computer) document or note in which the statement is recorded. From that source material, the date of recording can be determined.

The following table exemplifies the foregoing recordation principles:

| | | re- | | state- | | | |
|---|---|---|---|---|---|---|---|
| # | I | corder | recorded | ment | reliability | on | in |
| AT1 | I | Dr. X | recorded | AS1 | high | Oct. 01, 1999 | N1 |
| AT2 | I | | recorded | AS2 | moderate | | |
| AT3 | I | | recorded | AS3 | moderate | | |
| AT4 | I | Dr. X | recorded | AS4 | clinical | Oct. 08, 1999 | N2 |
| AT5 | I | Dr. Z | recorded | AS5 | high | Mar. 09, 1999 | Z's |
| | | | | | | | note |
| AT6 | I | | recorded | AS6 | clinical | | |

Reliability Scenarios:

Clinician-initiated assertions are objective data and, thus, do not generally require a reliability check or verification. A comment made by a patient, however, such as “My mother has never been hospitalized,” can be incorrect for a number of reasons:

Speculation (e.g., the person making the assertion was not told, but answered anyway)

Failure to remember

Purposeful misleading (e.g., a lie)

Incompetence (not understanding the question or being insufficiently rational enough to answer)

Mental health information systems according to the present disclosure can only know about statements if they have been entered into it. The person entering the statement is typically either the person who recorded it, for example when Dr. X's secretary (or other delegate) is entering Dr. X's notes, or alternatively, a transcription from an old record, such as when Dr. X is entering historical data found in Dr. Z's notes. Formally, an entered statement is a recorded statement with an entry clause. “On [date] I Secretary Y entered Dr. X's recorded statement [. . . ].” In the absence of delegates, it will always be the recorder who enters a statement. Statements are generally recorded in notes. A single note can naturally have several statements in it. It may be less obvious that, since a note can be saved and reopened over several sessions up to the point of signing, it is quite possible that the statements will get modified more than once, and that different users can be responsible for those modifications, as illustrated in the following table.

| # | I | user | entered | record | in note | on |
|---|---|---|---|---|---|---|
| E1 | I | Secy. W | entered or | R1 | N1 | Oct. 02, 1999 |
| E2 | | | modified | R2 | | |
| E3 | | Dr. X | | R3 | | Oct. 03, 1999 |
| E4 | I | Dr. X | entered or | R4 | N2 | Oct. 08, 1999 |
| E5 | | | modified | R5 | | |
| E6 | | | | R6 | | |

Preferred mental health information systems according to the present disclosure reflect the realities of statement entry by including identifying attributes with each statement:

Last Update User: This is the identification of the user who last modified the statement (or added it).

Last Update Date: This is the date when the statement was last modified.

Containing Note: This is the note in which the statement was added or modified.

When a note is signed (published) according to the present disclosure, all statements in the note become frozen. The authorized signer of the note is generally its author, and must be established at the time the note is created, as shown in the following table.

| # | I | author | signed | note | on |
|---|---|---|---|---|---|
| P1 | I | Dr. X | signed | N1 | Oct. 03, 1999 |
| P2 | I | Dr. X | signed | N2 | Oct. 09, 1999 |

Thus, according to preferred embodiments of the present disclosure, the following attributes are included with every note:

Author: This is a reference to the user who will be the author of the note.

Signing Date: This is the date the note was signed.

Once a statement has been defined with the above-mentioned attributes according to the present disclosure, the statement is ready to be rendered for presentation to the user. A sentence is broken up into a set of clauses and, for each clause, the set of attributes defining its value are associated therewith. Rendering a statement involves reversing that process. When rendering a statement, the disclosed mental health information systems typically group the clauses into four sentences:

The prefix provides the context for the occurrence, and thus renders the assertion and authoring clauses.

The body describes the occurrence, and thus renders the occurrence clause

The suffix describes how the statement has changed in the context it is being viewed, and thus renders the change clause

The appendix describes how the statement came to be, and thus renders the entry and signature clauses.

Taking the first statement from the clinical scenario presented above, preferred embodiments of the disclosed system would generate the following rendering:

| | |
|---|---|
| Prefix | As recorded in Dr. Y's note of Feb. 06, 1996, on |
| | Feb. 04, 1996 the patient's mother |
| | made the following statement. The |
| | statement's reliability is considered high. |
| Body | Patient's father diagnosed on XX/XX/1990 with |
| | 305.00 Alcohol Dependence, |
| | With Psychological Dependence. |
| Suffix | Added to note on Nov. 20, 1999. |
| Appendix | Entered by Clerk Z on Nov. 20, 1999. |
| | Signed by Dr. X on Nov. 21, 1999. |

The following table provides an overall attribute summary according to exemplary embodiments of the present disclosure:

| | | Statement Type | | |
|---|---|---|---|---|
| Information | | | Prospective | Prospective |
| Group | Attribute | Retrospective | Subjective | Objective |

| Statement | Source | Select SOI (default to pt). | User |
|---|---|---|---|
| | Occurrence | Statement class, type, and other attributes | |
| | Subject | Select | Patient |
| | Occurrence | Enter | From Note |
| | Date (Range) | | |

| | | | |
|---|---|---|---|
| Recording | Person of | Enter (default | Author |
| | Authority | to Author) | |

| | | |
|---|---|---|
| Reliability | Enter | Assumed |

| | | |
|---|---|---|
| Recording | Enter (default | From Encounter |
| Date | to Enc. date) | |
| Where | Enter (default | Containing Note |
| Recorded | to containing | |
| | note) | |

| | | |
|---|---|---|
| Entering | Last Update | Provided by system on update |
| | User | |
| | Last Update | Provided by System on update |
| | Date | |
| | Containing | Provided by system on statement creation |
| | Note | |
| Signing | Author | Entered on note creation |
| | Signing Date | Provided by system on note signing |

The unshaded attributes in the foregoing table are user-provided. As shown in the table, much of the information in an Operating statement can be inferred from the statement context, while for an Historical or Subjective statement, the information must generally be provided by a user. This would suggest that to make a statement historical or subjective, it is advantageously associated with an element that provides its historical attributes.

Persistence Rules are generally employed according to system(s) and method(s) according to the present disclosure. When a Version is created, Elements from prior Versions can appear “through” the form (as if it were a translucent sheet) to form a Baseline upon which changes (“deltas”) are enacted. Persistence Rules govern which of the myriad elements stored in the system will be brought into the Baseline for a particular Version, based upon the context of the particular Element (its Persistence Context) vs. the context of the baseline Version compared according to some Persistence Scope. The Persistence Scope can be determined for a class of Elements, or on an element-by-element basis according to the information represented in the element. Since some components of these contexts have a seemingly temporal relationship, Persistence Rules may be analogized to “aging rules”. However, Notes and Versions can and will be created in an atemporal sequence, so logical time rather than calendar time is used to evaluate the rules. In addition, the Persistence Context can include non-temporal components, such as which patient Chart holds those Elements.

There are a number of different components that generally make up the Persistence Context according to the present disclosure. For clinical data and especially Statements they nest into a hierarchy as shown in FIG. 7K.

From the editing Version in which the assertion has been documented (ThisVersId), the disclosed system/method can determine the Note, the EOC, the Chart (Entity Relationship), and the Target Entity, providing the Persistence Context for the Statement or other clinical Element, as shown schematically in FIG. 7L. The code letters ‘T’, ‘C’, ‘E’, ‘N’, and ‘V’ are used to flag the Persistence Scope, indicating which component of the Persistence Context should be used to match the context of a Baseline query: Target Entity, Chart (for a patient), Episode of Care (if defined), Note, or Version, respectively.

The Persistence Scope can be determined in different ways for different types of Elements. For demographic elements such as a name or address, the scope is defined as ‘T’ since this information persists unless explicitly changed. For Statements, the scope is determined on an element-by-element basis. The scope for any particular Statement is looked up in the PersistenceScope attribute of the catalog of Subject Entries, referenced from the Subject Entry selected for that Statement.

Once the scope has been determined, for a scoped element XYZ, the view XYZ_SCOPED_ASOF sits on top of the XYZ_ASOF view. For every ASOF_VERS_ID from the Cartesian join, it calculates the query's Persistent Context from the ASOF_VERS_ID and the Element's Persistence Context from its THIS_VERS_ID. In both cases, the calculation is achieved by joining VERSION, NOTE, and ENTITY_RELATION as shown in FIG. 7M. With both contexts available, the Persistence Scope is then used to switch on which components of the two contexts are compared. As mentioned before, this is generally taken from NODE_TYPE for the catalog NODE defining the type of Element, as illustrated in FIG. 7N.

For example, if E_VERS, E_NOTE, and E_ER are aliases for the joined VERSION, NOTE, and ENTITY_RELATION ASOF views for the Element, and Q_VERS, Q_NOTE and Q_ER are the same for the query, with NT the NODE_TYPE for the NODE of the Element, then the persistence expression would generally read along the following lines:

WHERE ... join up element and query persistence contexts ...
AND ((NT.PERSISTENCE_SCOPE = ‘V’ AND E_VERS.THIS_VERS_ID =
Q_VERS.THIS_VERS_ID) OR
(NT.PERSISTENCE_SCOPE = ‘N’ AND E_NOTE.NOTE_ID = Q_NOTE.NOTE_ID) OR
(NT.PERSISTENCE_SCOPE = ‘E’ AND E_NOTE.EOC_ID = Q_NOTE.EOC_ID) OR
(NT.PERSISTENCE_SCOPE = ‘C’ AND E_NOTE.ENT_REL_ID =
Q_NOTE.ENT_REL_ID) OR
(NT.PERSISTENCE_SCOPE = ‘T’ AND E_ER.ENT_ID = Q_ER.ENT_ID))

Elements are rendered into text or HTML form for display on screen and printing in reports. Rendering is accomplished using computed attributes which process field values from the Element into rendered strings, generally specified in software code or in a preferred embodiment by applying a template with non-specific software code. The rendering takes into account the hierarchical nature of Elements such as that between Statements and Qualifiers: A Statement can coalesce the rendered text/code of all its associated Qualifiers, and a Qualifier can coalesce the rendered text/code of all its child Qualifiers. The user interface or a report generator can choose to display coalesced values, or separately list the uncoalesced values. The diagram of FIG. 70 shows the foregoing hierarchical coalescence. Of note, the same basic rules are used for the xxxText and xxxCode attributes, so these are shown in FIG. 7O and subsequent discussion as xxxText|Code.

In an exemplary embodiment of the present disclosure, the Node Type of each of the three Statement Nodes and each of the three Qualifier Nodes are tightly bound to the data-driven user-interface building mechanism for Note Panes.

A Statement generally includes references to a network of other Versioned Data Elements, any of which can be independently modified. These references can be divided into three different categories:

Those that are never displayed with the Statement. These would include, for example, the Address of an Entity referenced by the Statement. No version skew detection is needed.

Those that are displayed with the Statement but for which version skew detection is not legally/clinically mandated. These would include the Primary Name of an Entity. These would also include all reference data (MetaCatalog Nodes) referenced by the Statement and its referenced Elements.

Those that are displayed with the Statement and for which failure to warn about skew when a Statement is elevated might cause a user to sign information they are not aware of changes in. These include the Encounter and the Entity Relationship between any referenced Entities and the Target Entity (including in qualifier Responses).

A diagram of the Elements referenced by a Statement are shown in FIG. 7P. Undisplayed elements are shown with greyed labels or connectors, while displayed but not Skew-detected elements are shown as dashed. As shown in the diagram of FIG. 7P, the disclosed system is generally required to check only the following records to see if the Statement will undergo version skew when elevated:

Encounter

Encounter's SOR's Entity Relation (to Target Entity)

Encounter's SOI's Entity Relation (to Target Entity)

Response's AnswerEntity's Entity Relation (to Target Entity)

Response's Response's . . . AnswerEntity's Entity Relation (to Target Entity)

The detection of skew can generally be handled according to the present disclosure by adding the following VersionSkewTf attributes to the various objects; starting from the bottom:

| Element | Attribute | Skew Detection Formulation Pseudo-code |
|---|---|---|
| Qualifier | EntitySkewTf | hasSkew(EntityAnswer.RelationToTarget) \|\| |
| | | OR(Children, EntitySkewTf) |
| Encounter | SOISkewTf | hasSkew(SOI.RelationToTarget) |
| | SORSkewTf | hasSkew(SOR.RelationToTarget) |
| Statement | EncSkewTf | hasSkew(Encounter) |
| | VersSkewTf | EncSkewTf \|\| Encounter.SOISkewTf \|\| |
| | | Encounter.SORSkewTf \|\| |
| | | Qualifier.EntitySkewTf |

Of note, hasSkew(e) equates to checking whether e.ThisVersld>relative to the baseline VersId for the target element (Statement in this case). Note also that RelationToTarget requires both the SourceEntId and TargetEntId.

Once the presence of any skew is detected via the Statement.VersSkewTf attribute, a dialog is typically shown indicating the occurrence of version skew; the individual XxxSkewTf skew-detection attributes can be used to provide the user with a detailed message by conditionally enabling or disabling the following condition lines:

| Element | Column | Message Line |
|---|---|---|
| Response | EntitySkewTf | A referenced Person or Institution |
| Encounter | SOISkewTf | The Source of Information for the Encounter |
| | SORSkewTf | The Source of Report for the Encounter |
| Statement | EncSkewTf | The Encounter details |

In order to correct skew, exemplary embodiments of the present disclosure add a SkewVersId attribute to the Statement and use that (rather than the editing Version's ThisVersId field) as the AsofVersId for Asof queries originating from the Statement. It is important to note that, when a Statement is elevated, it is essential that the Version's ThisNoteId (which ends up being the AsofVersId for the Statement query) must be copied into both the Statement's ThisVersId and SkewVersId.

According to preferred embodiments of the present disclosure, a Statement Composer/Editor is provided that constitutes perhaps the most frequently used tool in mental health information system(s), as disclosed herein. The Statement Composer is generally brought up in one of two states, based on the EditMode parameter set by the calling context:

In Create mode, a new Statement is being created. This is done by creating a provisional Statement and then editing it. Any of the fields making up the Statement, including its Statement Type, can be edited. In this mode, pressing the Insert button adds the provisional Statement to the Statement List and creates a new provisional Statement, leaving the Statement Composer up.

In Edit mode, an existing Statement is being edited. This could be a Statement elevated from the baseline, or one created during a prior invocation of the Statement Composer in Create mode. The Statement Type is frozen, but other fields of the Statement can be changed.

The Statement Composer is typically composed of the following sections:

Statement Type Selector—A drop-down which, in Create mode, allows the choice of a Statement Type from a catalog of Statement Types appropriate to the context in which the composer is shown.

Context Editor—Allows the Statement Context to be edited for the current Statement. The Context Editor may include, for example, the Subject, Start Date, and End Date of the event, and the Encounter and Comment fields. The fields are selectively shown based on the selected Statement Type.

Statement Subject Chooser—Allows selection of a Subject Catalog from among one or more choices corresponding to the chosen Statement Type, and selection of a Subject from within the chosen Subject Catalog.

Subject Detail Panel—An which has additional editing controls for providing more information about the Subject (level 5 of the Note Pane data-driven construction described herein). The configuration is dependent on the chosen Subject Choice Node, typically either a blank panel for subjects which have no detail, or a Qualifier Editor that allows responses to be provided for a tree of Qualifiers corresponding to each Qualifier node attached to the Subject Entry Node.

Rendered Statement Preview—A text area showing what the composed/edited Statement looks like when rendered.

Composer Toolbar—Tools for accepting/rejecting the work and popping down the panel.

Incoming Parameters for the Statement Composer generally include:

| Parameter | Formulation |
|---|---|
| Version | The Version we are editing, referred to as the |
| | Bound Note Version |
| StmtTypeList | The list of Links referring to the Statement Types |
| | which can be chosen by the user. |
| Statement | The Statement being edited when in editing mode, |
| | empty for creation. |
| StatementList | The Statement List to which newly created Statements |
| | should be added, can be NULL if a single |
| | Statement (already in a Statement |
| | List) is being edited. |
| EditMode | Whether we are in Compose mode (false, default) |
| | or Edit mode (true). Changes the |
| | behavior of the interface. |

Local parameters associated with the Statement Composer generally include:

| Parameter | Formulation |
|---|---|
| Note | Calculated as Version.Note |
| ReferenceEntRelId | Calculated as Note.EntRelId; used to initialize |
| | new Statements in Compose mode. |
| ReferenceEntId | Calculated as Note.EntRel.SourceEntId; ditto. |

The operation of the aformentioned components is herein detailed:

The Encounter Chooser is a drop-down menu of existing Encounters within the current Episode of Care (EOC). The Encounter List is chosen from EocEncounterList, i.e., the list of Encounters in the current EOC. Each Encounter is displayed as a string joining the EncounterStartDt with the Short Name of the SOI entity and the relationship between the SOI and the Target Entity. Selection sets the Current Encounter to the selected one. All Statements created in the Statement Composer will have the EncounterId field set to that of the Current Encounter or to NULL if there is no encounter. The [symbol] choice/button pops up the Encounter Editor, allowing the creation of new Encounters and editing/revision of existing Encounters.

A Statement Type Selector is a drop-down which allows the Statement Type to be selected from the list provided in ref:StmtTypeList. The current choice is bound to ref:Statement.StatementType. The Statement Type Selector is disabled if the Statement being edited was not created in the current Version, e.g., if there is a signed version containing the Statement, irrespective of whether the user is creating a new Statement or editing an already-composed Statement; all that counts in preferred embodiments of the present disclosure is whether the Statement lies within a signed (committed) Version. This can be detected by making sure the record being edited has been elevated with a type of ‘I’, e.g., ThisVersId=AsofVersId & DeltaCode=‘I’ which is computed in the Statement's computed attribute IsInsertedTf. The ChoiceLabel of each Statement Type Node is displayed, e.g., ref:Node.ChoiceLabel, and when a selection is made in the Statement Type Selector, the Context Editor section must be switched to show a context appropriate to the Node Type of the selected Statement Type (see below).

The Context Editor allows setting of the Statement Context for new Statement(s) created by the Statement Composer. The Context Editor is context-sensitive, only showing those parameters which are appropriate to the current Statement Type, as determined by ref:StatementType.NodeType.InterfaceModule. This context-sensitivity can be provided in at least two ways:

A pane with several fixed variants, switched according to attributes determined from the Statement Type.

A pane which dynamically loads externally stored variant modules named according to attributes determined from the Statement Type.

Typical controls within the Context Editor include the following:

| Control | Binding | Description |
|---|---|---|
| Pertains to | SubjectEntId | Who the Statement will pertain to, |
| | | selected from the Related Entity List. |
| | | Each Entity is displayed as a |
| | | concatenation of |
| | | PreferredName.ShortName with |
| | | TargetRelListAsof.Rela- |
| | | tionType.FormalText. The [symbol] |
| | | choice brings up the Related Entity |
| | | Chooser/Composer. |
| Start Date | A fuzzy date for when the event began or occurred. | |
| | Composed of two fields: | |
| | EventStartFuzz | a drop-down choice field with |
| | | choices from the catalog “Date Fuzz |
| | | Choices” |
| | EventStartDt | a date field |
| End Date | A fuzzy date for when the event ended. Composed | |
| | two fields: | |
| | EventEndFuzz | a drop-down choice field with |
| | | choices from the catalog “Date Fuzz |
| | | Choices” |
| | EventEndDt | a date field |
| Encounter | Encounter | A scrollable text field with the |
| | | Encounter information in it. |
| Comments | Comments | A scrollable text field with the |
| | | Comments information in it. |
| [symbol] button | n/a | Sets SubjectEntId to ReferenceEntId, |
| | | StartDate to today, StartFuzz to |
| | | “On”, EndDate to today, EndFuzz to |
| | | “<no selection>”, and Comments to |
| | | blank. Encounter should not be |
| | | touched. |

The list RelatedEntityList of Related Entities is used for the SubjectEntId choice and as subsequently described, for the Subject attribute of Qualifiers. It is generated according to the present disclosure by traversing from Statement.ReferenceEntId to TargetRelationListAsof, generating an entry for every Entity related to the Reference Entity of the Statement.

A Statement Subject Selector may be provided according to the present disclosure that generally constitutes a set of two inter-linked choices, the Subject Catalog Selector and the Subject Entry Selector, bound to two levels of the MetaCatalog descending from the Statement Type.

The Subject Catalog Selector is typically a drop-down choice allowing a Subject Catalog to be selected from those appropriate to the Statement's Statement Type. It is generally bound to Statement.SubjectCat and the list of choices is generated by traversing the Statement Type's HasA links, e.g., ref:Statement.StatementType.HasAChildren.

The Subject Entry Selector is typically a scrolling Tree allowing a Subject Entry to be selected from those appropriate to the Statement's Subject Catalog. It is bound to Statement.SubjectEntry and the list of choices is generated by traversing the Subject Catalog's HasA links, e.g., ref:Statement.SubjectCat.HasAChildren.

The ChoiceLabel of the selected Nodes (Subject Catalog and Subject Entry) are typically displayed in each widget. When a selection is made in the Subject Entry Selector, a sub-pane appropriate to the selected Subject Entry Node (as typically specified by the InterfaceModule field of its NodeType) is swapped or loaded into the Subject Detail Editor pane in like manner as heretofore described for the Context Editor pane. Typically most Statements will specify the Qualifier Editor pane for their subject detail editor.

The valid Qualifiers attached to a Statement are determined by its Subject Entry, and so existing qualifiers must generally be removed and new ones created when the Subject Entry changes. In exemplary embodiments of the present disclosure, this step is performed in a selection action handler on the Subject Entry Selector, rather than the Subject Detail Pane. In such case, the action handler generally performs the following functions:

Iterate each existing Qualifier for the Statement (found via the Statement.QualifierList) and delete it.

Iterate over each Qualifier Node specified by the newly chosen Subject Entry (found via the SubjectEntry.HasAChildren link) and create a new Qualifier record for each, using the Statement to initialize the Qualifier so the StatmentId, NoteId, ThisVersionId, and other fields may have correct values, and setting QuestionNodeId to the TargetNodeId of the iterated Link.

Since Qualifiers are arranged as a tree, after creating a Qualifier, preferred systems according to the present disclosure immediately iterate the IsAChildren of the Qualifier Node (e.g., from the link, Node.IsAChildren) and create child Qualifiers for them. In this case, the disclosed system would use the parent Qualifier to initialize its child Qualifiers so that StatementId, NoteId, ThisVersionId, ParentId, and other fields will have correct values, and the QuestionNodeId can be set to the TargetNodeId of the iterated Link. The foregoing step may be performed recursively, or at least a fixed number of levels, so that the system can accommodate a deep qualifier tree.

A Subject Detail Panel according to the present disclosure shows an interface appropriate to the Subject Entry of the Statement. In exemplary systems according to the present disclosure, the Subject Detail Panel can be hardwired to display the Qualifier Editor pane.

A Qualifier Editor pane according to the present disclosure contains a small area for each Qualifier, typically arrayed vertically and enclosed within a scrolling pane. Each such area displays a Qualifier Editor module containing a label and zero or more input controls allowing a response to be provided as appropriate to the type of Qualifier. Since the Qualifiers are structured hierarchically, the Qualifier Editor can be constructed using a typical Tree control, or through other means such as recursive inclusion of panels within panels.

One of several different Qualifier Editor interface variants are displayed for any particular Qualifier based on the Qualifier Question Node's attributes, e.g ref:Qualifier.QuestionChoice.NodeType.InterfaceModule. The variants can be statically defined or better dynamically loaded from an external module specification as heretofore described for the Context Editor and Detail Editor. In general, the various Qualifier Editor will display two items:

The Qualifier's Question's Choice Label is displayed as the Qualifier Editor's label. This is found from ref:Qualifier.QuestionChoice.ChoiceLabel.

One or more of the Qualifier's various AnswerXXX fields are bound to input controls as appropriate to the Question. These are typically lined up vertically or horizontally as best fits.

Behavior of the various controls includes but is not limited to the following:

When a Qualifier Editor module specifies a Catalog Choice, the AnswerCat field of the Qualifier will supply the Answer Catalog, and the AnswerChoice field will supply the Answer Choice. From ref:QuestionChoice.HasAChildren, the disclosed system generally obtains the Catalog Group, a list of potential Answer Catalogs, and from ref:AnswerCat.HasAChildren, the system generally obtains the Catalog, a list of potential Answer Choices, which are bound to a drop-down menu. There may be a [symbol] tool added to the menu which pops up the Catalog Entry Chooser/Composer/Editor, binding Catalog, CatalogGroup, CurrentEntry, and NoteVersion.

When a Qualifier Editor module specifies an Entity Choice, the AnswerEntity field of the Qualifier will typcially be a reference to an Entity. The previously mentioned catalog of Related Entities is generated by traversing from the Qualifier to the Statement to the Reference Entity and to SourceRelationList; this gives the Entity Relations, so they are displayed by traversing to TargetEntity and joining PreferredName.ShortName with the Relationship label in parenthesis. There is typically a [symbol] tool added to the menu which pops up the Related Entity Chooser/Composer/Editor, binding SourceEntity to ref:Qualifier.Statement.ReferenceEntity and TargetEntity to ref: Qualifier.AnswerEntity.

Other input types, such as for text, numbers, and dates and/or times, are simply bound to the corresponding fields in the Qualifier.

The Rendered Statement section is generally a scrollable text area showing the rendered Code field of the Statement (if it has a code) joined with the rendered Text field. It will dynamically update as changes are made to the Statement Context, Subject Chooser, and Subject Detail sections.

On the Composer Toolbar, a [symbol] button is typically visible only in Edit mode, e.g., when EditModeTf is true. The action of the button is to pop down the Statement Composer panel. A [symbol] button may be provided with the intent that users be allowed to cancel edits in Edit mode. A [symbol] button may also be provided that is generally visible only in Create mode, e.g., when EditModeTf is false.

In preferred embodiments of the present disclosure, the Statement Composer panel is closed after doing any needed cleanup, e.g., by performing the following steps:

Delete the provisional Statement's qualifiers as heretofore described for changes in the Subject Entry Selector.

Delete the current Statement as held in ref:Statement

Pop-down the Statement Composer panel

An [symbol] button is typically visible only in Create mode, e.g., when EditModeTf is false. The button facilitates creation of a Statement and prepares for the next Statement to be created, and performs the following steps:

Adds the Statement held in ref:Statement to ref:StatementList

Creates a new Statement and store it in ref: Statement. The new Statement will be initialized from the prior Statement (with appropriate default values if there is none such) such that StatementId, SubjectEntId, TargetEntId, EncounterId, EventStartFuzz, EventStartDt, EventEndFuzz, EventEndDt and Encounter attributes and the standard Element versioning attributes will be properly set. The Comment field is typically set to NULL since it does not carry forward from Statement to Statement.

Creates a tree of Qualifiers for the new Statement corresponding to its initial Statement Type, as heretofore described for changes in the Subject Entry Selector.

To facilitate implementation and maintenance of the action/reaction code, particularly in view of the potential for such code to spread throughout this module and its containing context (e.g. the NoteSectionStmtBlock module), two potential programming approaches are contemplated according to the present disclosure:

Create a Statement.java class (in a special package of application-logic-specific classes) which has centralized methods to create a provisional statement, delete qualifiers, add new qualifiers, etc.

Implement a macro facility, e.g. in XML<method name=“xxx”><reaction . . . >* </method>which allows a set of reactions to be bound to a user-interface element without changing the source code of the user interface.

Implement a macro facility, e.g. in XML<method name=“xxx”><reaction . . . >* </method>which allows a set of reactions to be bound to a data element without changing the source code of the data element.

A Catalog Entry Chooser/Editor is provided that generally serves the following general purposes:

Facilitate the user's choice of an Entry by choosing from one or more Catalogs comprising a Catalog Group, and browsing its Entries in a tree format.

Facilitate the choice of an Entry by performing a wild-card search within the selected Catalog.

Where permitted, provide for the creation of ad-hoc choices (Entries) when no existing choices serve the user's needs.

Where permitted, provide for the editing of incorrect entries and/or withdrawal of obsolete entries.

The Catalog Entry Chooser/Editor is typically popped up from contexts in which entries are chosen from one or more MetaCatalog Catalogs comprising a Catalog Group. An example is a Statement Qualifier choice drop-down. When a Catalog Group is mapped to a drop-down menu, only the currently chosen Catalog in the group (by default the first one) supplies Entries to the drop-down. Furthermore, resource and user-interface considerations require limiting the number of choices shown in a drop-down to a relatively small number, e.g., fifty. Finally, interface real-estate limitations may cause truncation of the labels shown in a drop-down menu. Thus, any drop-down menu with one or more of: (i) very long choice label strings; (ii) very long catalog of choices; and/or (iii) more than one catalog of choices, should include a [symbol] entry which brings up the MetaCatalog Chooser/Editor. Depending on the context and the user's permissions, this may be set to come up in either read-only mode (browse and search) or read-write mode (with add/modify privileges).

Incoming parameters according to the following disclosure include:

| Parameter | Formulation |
|---|---|
| Version | The Version record from which MetaCatalog entries |
| | will be queried and (if signed) where edits will be posted. |
| CatalogGroup | The Node from which we will obtain the group of |
| | Catalogs from which an Entry can be selected. |
| | The Node is traversed via HasAChildren to obtain |
| | the root Catalogs, and these will be traversed |
| | via IsAChildren to obtain a hierarchy of Catalogs. |
| CurrentCatalog | The Node (from among those reachable from |
| | CatalogGroup) which represents the currently |
| | selected Catalog when the CEC is popped up, |
| | and which will have the final Catalog choice |
| | when it is popped down. |
| CurrentEntry | The Node (from among those reachable from |
| | CurrentCatalog) which represents the currently |
| | selected Entry when the CEC is popped up, |
| | and which will have the final Entry choice |
| | when it is popped down. |

The Catalog Entry Chooser/Editor is generally a modal popup pane. It is typically vertically divided into three parts:

The Catalog Chooser dropdown menu. This allows one Catalog to be chosen from one or more in the Catalog Group.

The Catalog Browser tree. This allows one Entry to be selected from the current Catalog.

The Toolbar. This allows popping down of the pane with or without changing the selected Catalog Group and Catalog Entry in the bound data element.

The Catalog Chooser allows one Catalog from the Catalog Group to be chosen. The root list of Catalogs is generally generated by traversing via CatalogGroup.HasAChildren. The selected Catalog is bound to CurrentCatalog. Any child Catalogs are typically displayed by traversing via the IsAChildren path. The list/tree of Catalogs is bound to a drop-down choice. As is typical, each Node is displayed using ChoiceLabel, and has selectability bound to NodeType.IsSelectableTf. The current selection is generally bound to CurrentCatalog.

The Catalog Entry Browser is a tree showing all Catalog Entries in the currently selected Catalog. The root list of Entries is typically generated by traversing via CurrentCatalog.HasAChildren. Any child Entries are displayed by traversing via the IsAChildren path. The list/tree of Entries is bound to a Tree choice. As is typical, each Node is displayed using ChoiceLabel, and has selectability bound to NodeType.IsSelectableTf. The current selection is bound to CurrentEntry.

The toolbar typically includes a [symbol] Button that functions as the OK button, storing the currently selected Catalog and Catalog Entry into the destination record and popping down the Catalog Entry Chooser/Editor. A [symbol] Button pops down the Catalog Entry Chooser/Editor without changing the Catalog and Catalog Entry fields in the destination record.

A Related Entity Chooser/Editor facility is quite similar to the Catalog Entry Chooser/Editor except that the items being chosen and/or edited are Entities (persons, institutions) related to a defined Reference Entity. Either a pre-existing Entity without a current relationship to the Reference Entity can be related to the Reference Entity by creating a Relationship of a particular type (chosen from an appropriate catalog of potential relationship types) between the pre-existing Entities, or alternately a new Related Entity and such a Relationship an be created in a single operation.

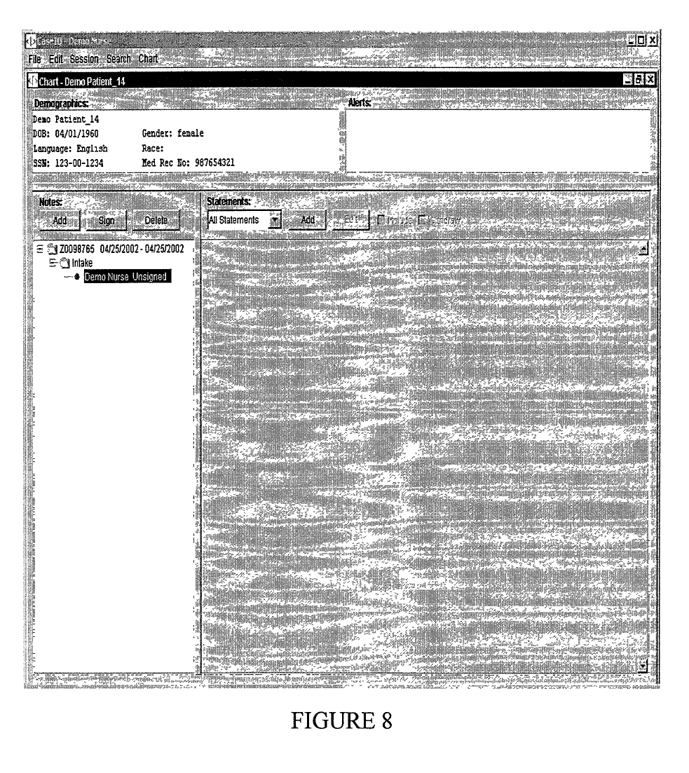

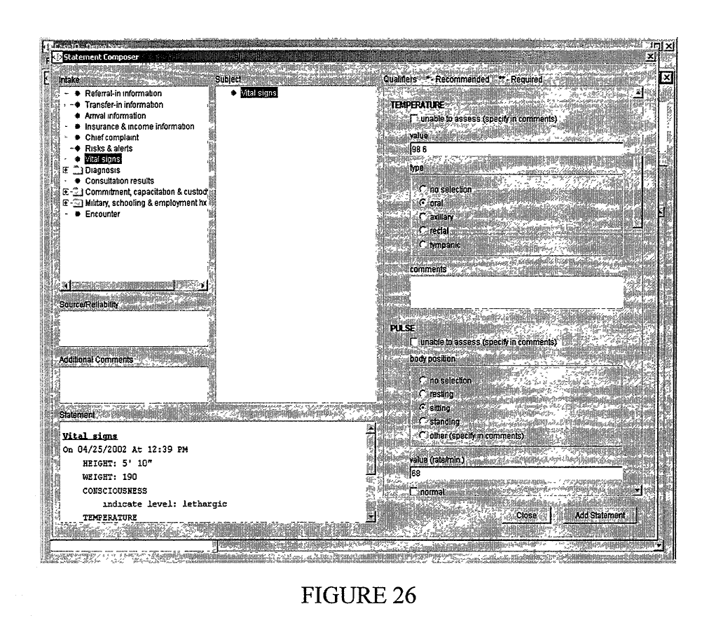

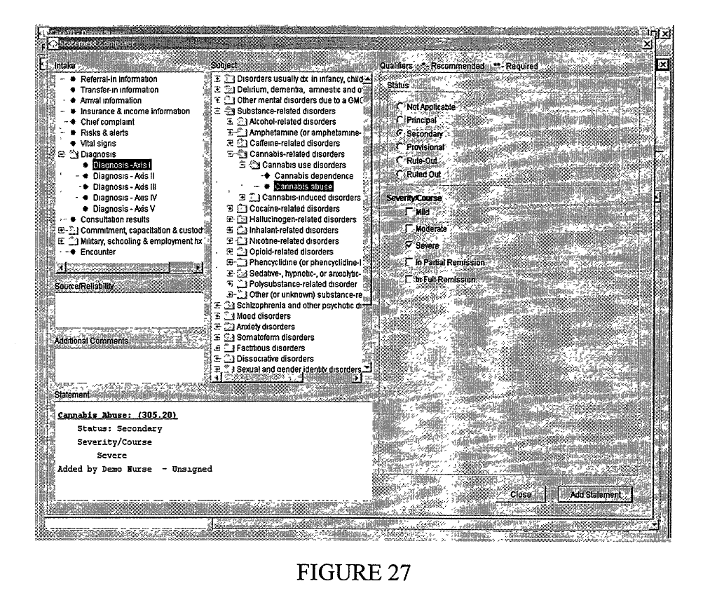

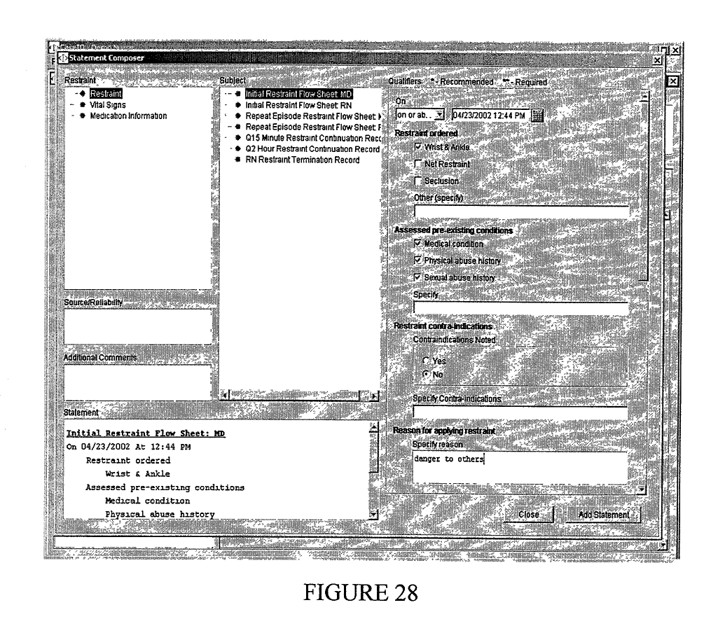

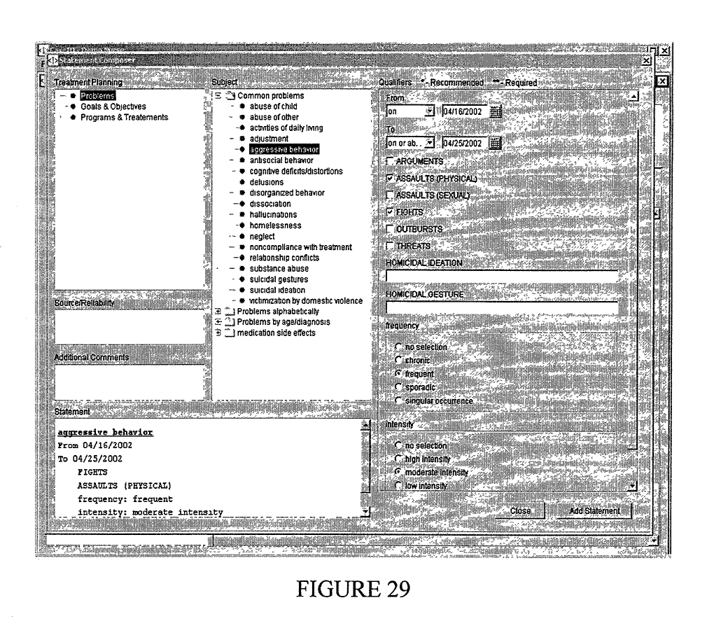

As mentioned previously, FIGS. 8-29 illustrate an exemplary embodiment of the present disclosure that is an Electronic Patient Record (EPR) system for the field of behavioral health. These figures are now described in further detail.

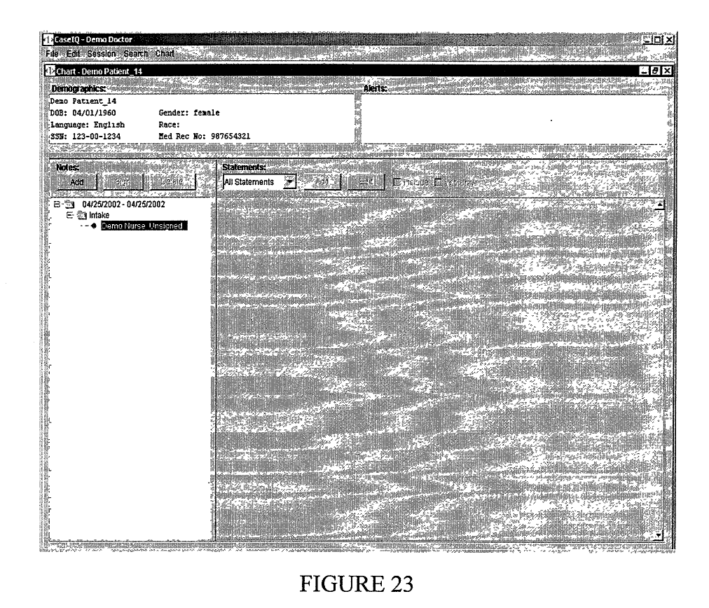

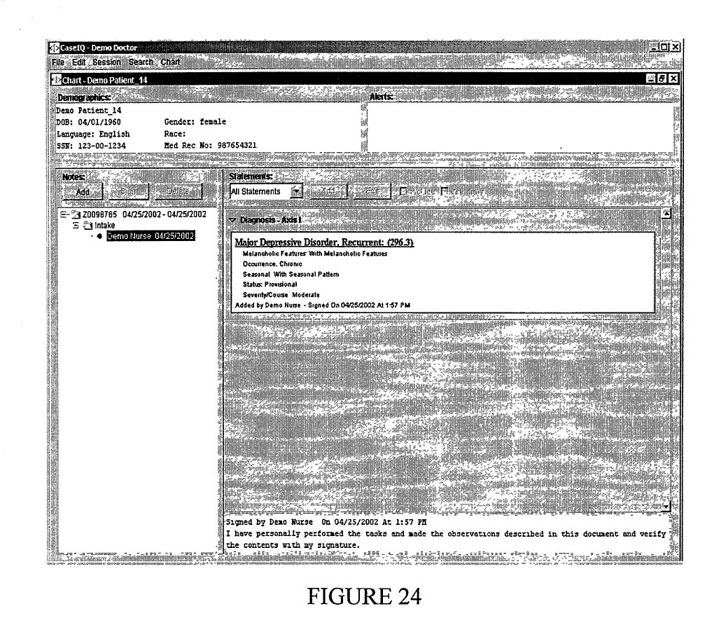

FIGS. 8-22 show a preferred sequence of steps a user would take in creating a note version containing, in this example, a single statement, according to the exemplary EPR system. FIGS. 23 and 24 illustrate the visibility of the information to other users at several steps in the process.

FIG. 8 depicts an exemplary screen at the point when the user (named Demo Nurse in this example) had accessed the chart for the patient of interest. In this example the patient is named Demo Patient_{—}14, was born on Apr. 1, 1050, is female, speaks English, and has a social security number 123-00-1234 and a medical record number 987654321. At this point the user has created a new (and therefore unsigned) note version of an Intake note type. In FIG. 8, this note version is highlighted. The user would then click on the “Add” button in the Statement section of the Chart Pane to bring up the Statement Composer.

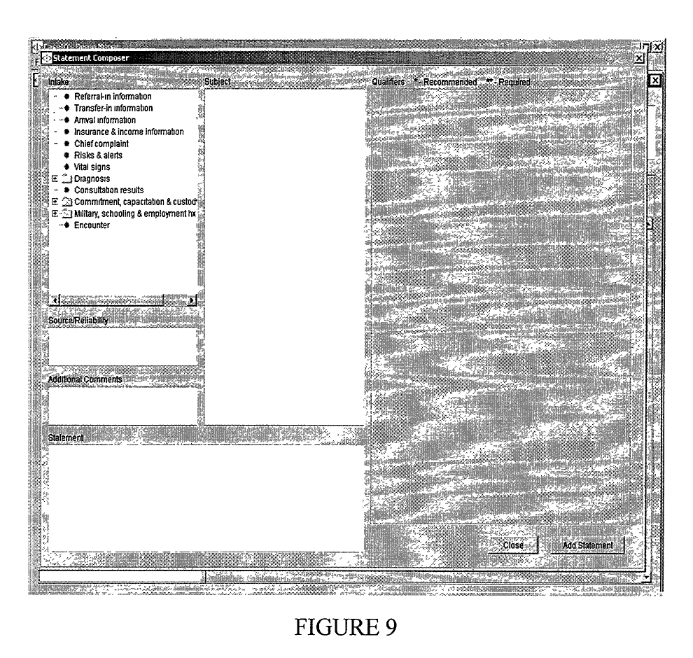

FIG. 9 depicts a screen that is viewed following the clicking on the “Add” button shown in FIG. 8. At this point the Statement Composer is visible. Near the upper left of the screen the word “Intake” is seen, reminding the user that he/she is working on an Intake note. The tree just under the word Intake depicts various types of statements that can be part of an Intake note, according to this exemplary embodiment of a behavioral health system. The mapping of these statement types to the note type of Intake is advantageously contained in the metadata that has been provided to the system. The user then clicks on the plus sign to the left of the word “Diagnosis” in the displayed tree to reveal the choices of statement types available under Diagnosis.

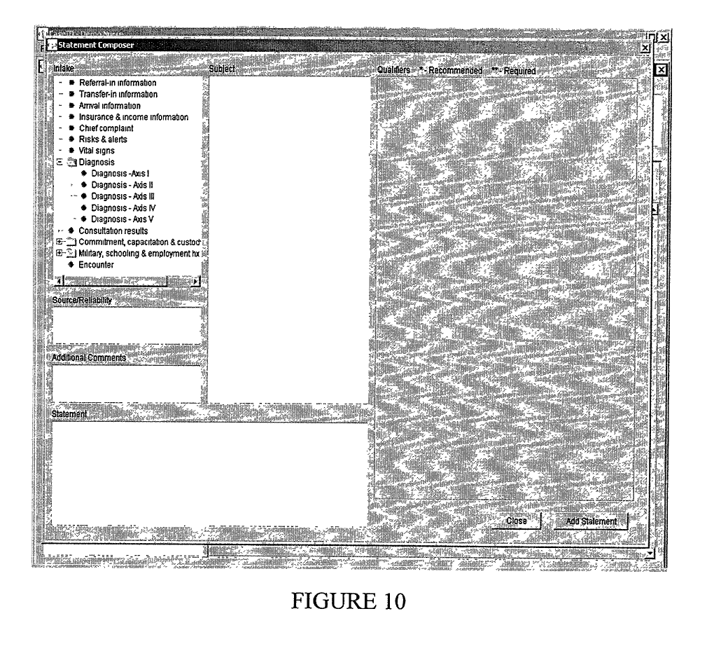

FIG. 10 depicts a screen that may be viewed following the clicking on the plus sign to the left of the word Diagnosis shown in FIG. 9. Five choices are now available under Diagnosis, namely, the five Axes of Diagnosis defined in DSM-IV-TR. The user would next typcially select the Diagnostic Axis of interest, in this example, an Axis I Diagnosis.

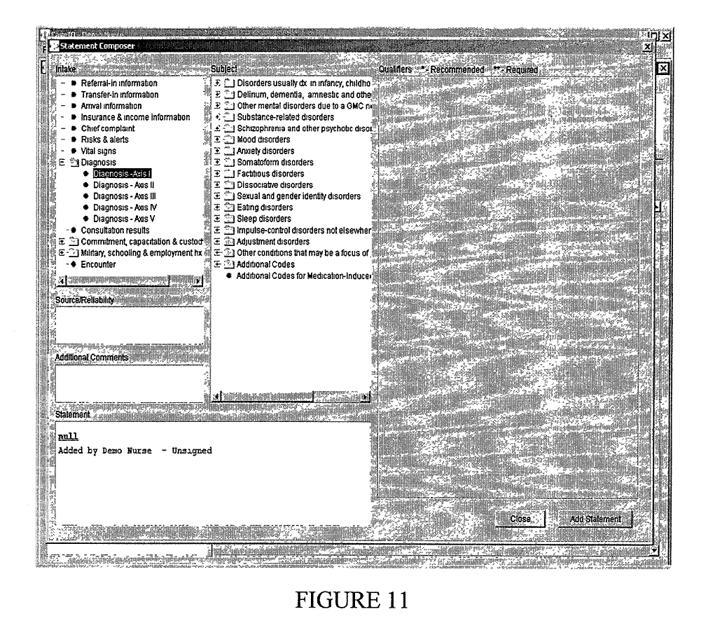

FIG. 11 depicts a screen that may be viewed following the selection of an Axis I Diagnosis from the screen shown in FIG. 10. The selection of the Axis I Diagnosis has caused the system to display in the panel in the center of the screen the various subjects of an Axis I Diagnosis. These subjects are defined in the DSM-IV-TR and are advantageously provided to the system as metadata. The user would then typically proceed to expand the subject tree until the subject of interest has become visible by progressively clicking on the plus signs to the left of the branch of the tree of interest. In this example, the user next selects the plus sign to the left of the subject “Mood disorders.”

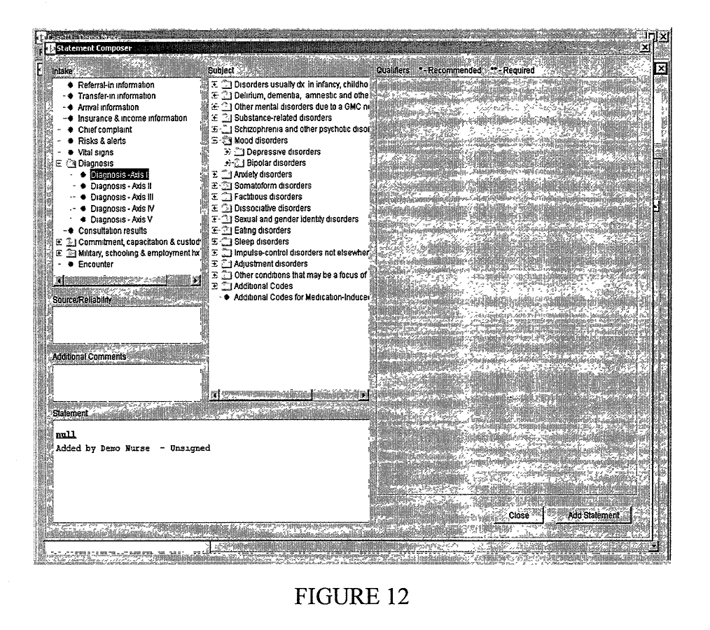

FIG. 12 depicts that the selection of the plus to the left of “Mood disorders” has revealed two additional choices. In this example, the user next clicks on the plus to the left of “Depressive disorders.”

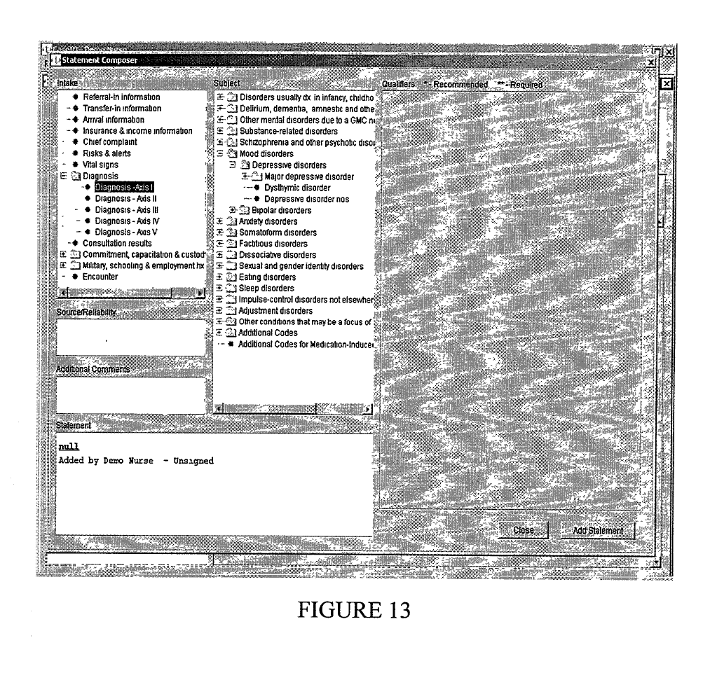

FIG. 13 depicts that the selection of the plus to the left of “Depressive disorders” has revealed three additional choices, one of which contains additional choices within it and two of which are leaves of the tree rather than branches. In this example, the user next clicks on the plus to the left of “Major depressive disorder.”

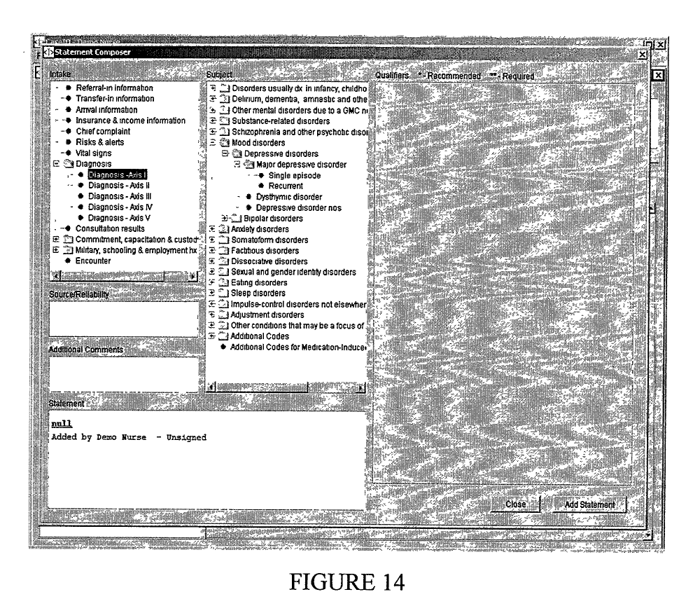

FIG. 14 depicts that the selection of the plus to the left of “Major depressive disorder” has revealed two choices, neither of which has any sub-choices below it in the tree. The entire tree of Subjects, from Mood disorders through the two choices for Major depressive disorder, is defined in the DSM-IV-TR and is provided to the system as metadata. In this example the user next selects “Recurrent.”

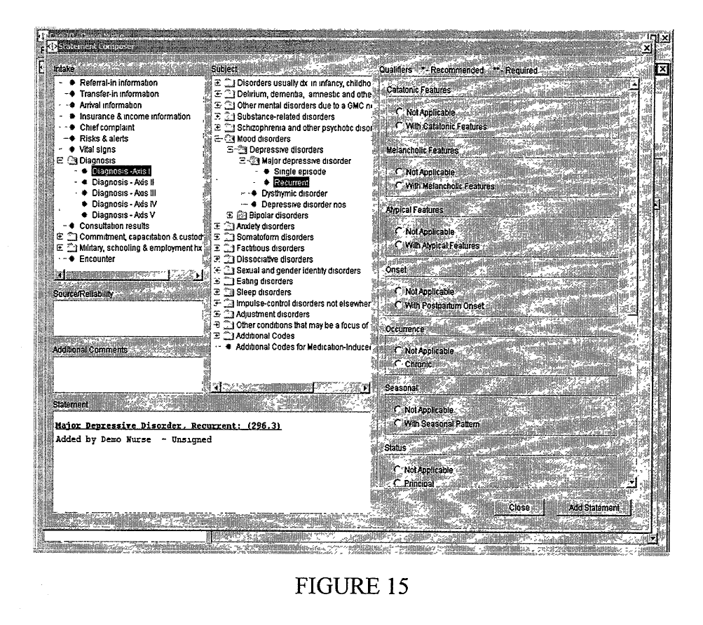

FIG. 15 depicts an exemplary screen that is viewed following the selection of “Recurrent.” This selection has revealed a set of Qualifiers, shown in the panel on the right of the screen, that are specific to an Axis I Diagnosis of a recurrent major depressive disorder. In addition, the Statement Panel that can be seen in the lower left of the screen has begun rendering the statement that is being composed; in this panel, the system now displays the diagnosis that has been selected, the code from the DSM-IV-TR that corresponds to this diagnosis (296.3 in this case), the fact that the author of this note is Demo Nurse, and the fact that the note is currently unsigned. To continue composition of the subject statement, the user would then proceed to select among the choices presented in the Qualifier Panel on the right of the screen.

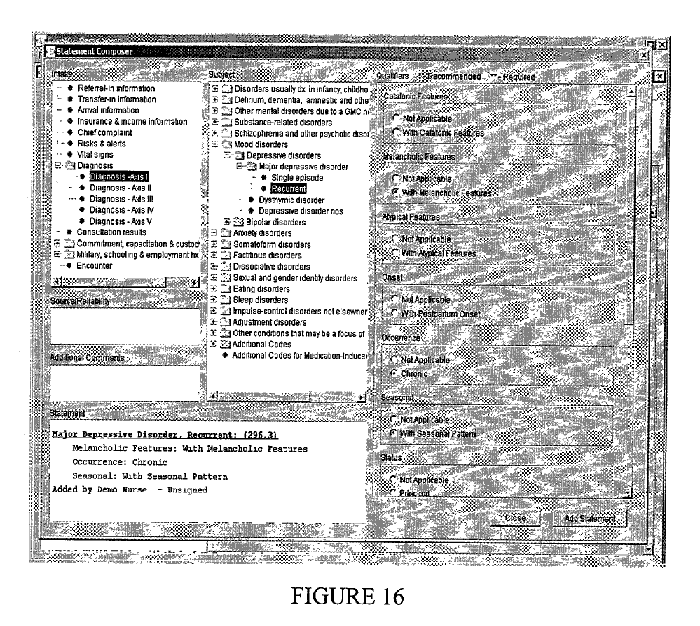

FIG. 16 depicts an exemplary screen that is viewed following the selection of three of the choices in this example. The rendered statement in the lower left panel of the screen now reflects these three choices: melancholic features are present, the occurrence is chronic, and that there is a seasonal pattern. To get to the choices further down in the list of qualifiers, the user would use the scroll bar to the right of the Qualifier Panel to scroll down to the next set of choices available.

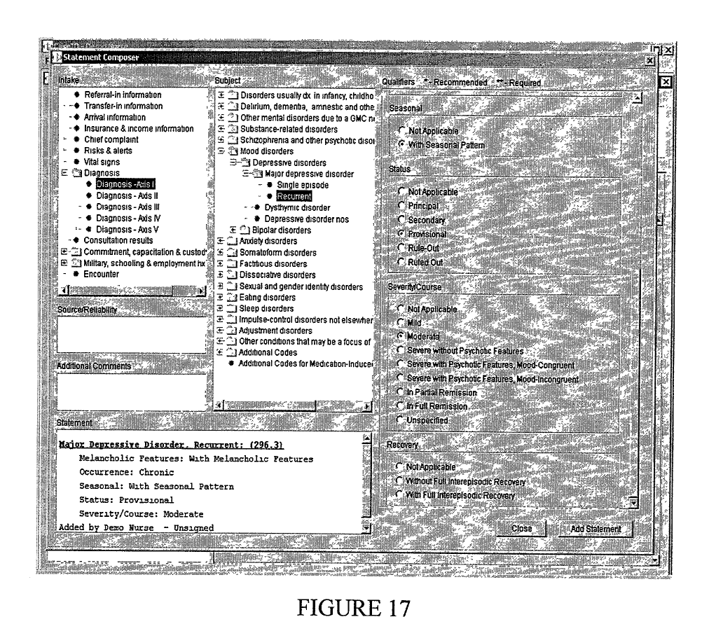

FIG. 17 depicts the screen that is viewed according this exemplary embodiment of the present disclosure following scrolling down the list of qualifiers and the selection of two additional qualifier responses: the status of the diagnosis is provisional and the severity/course is moderate. These additional choices are now reflected in the rendering of the statement in the lower left of the screen. For purposes of this example, the user has now completed composing the statement and adds the statement to the unsigned note by clicking on the “Add Statement” button in the lower right of the screen.

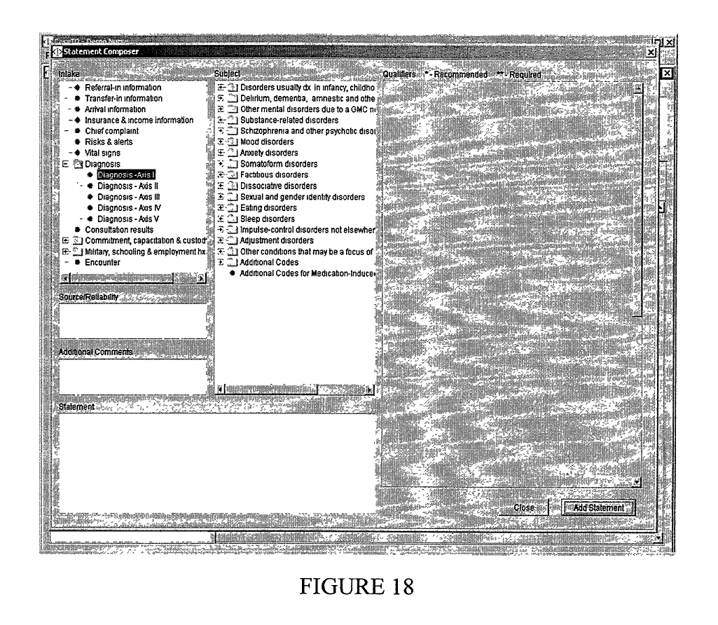

FIG. 18 depicts an exemplary screen that is viewed following the clicking on the “Add Statement” button. The statement composer typcially remains open should the user wish to compose additional statement(s) and add them to the Intake Note, but the selection of a particular subject has been removed and the Qualifier Panel on the right of the screen is now blank, as it was prior to FIG. 15. In this example, there is only a single statement to be added to the Intake Note, so the user would next click on the “Close” button in the lower right of the screen to close the Statement Composer and return to the Chart Pane.

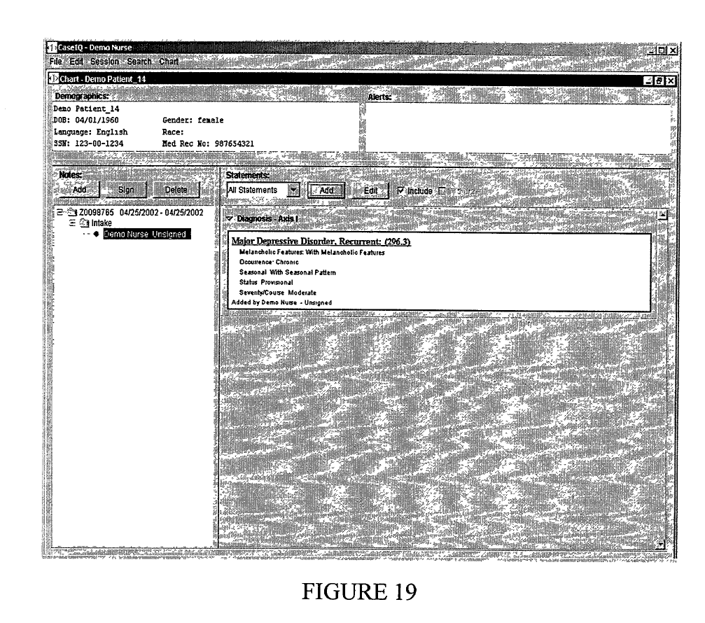

FIG. 19 depicts an exemplary screen that is viewed following the closing of the Statement Composer. The rendered statement now appears in the Statement section of the screen. In this example, the user next chooses to sign the statement, thereby rendering it immutable and publishing it to all who have appropriate levels of permission to read it. To do this, the user clicks on the “Sign” button in the Note Panel of the screen.

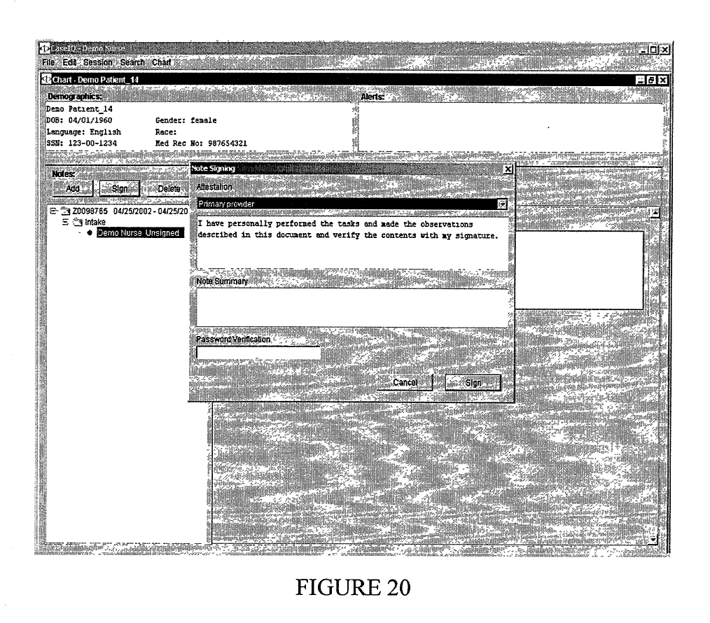

FIG. 20 depicts an exemplary screen according to the disclosed behavioral health system that is viewed following the clicking on the “Sign” button. The Note Signing Popup is now visible in the center of the screen. Using this exemplary popup, the user chooses an attestation, adds an optional note version summary, and signs the note version by entering his or her password. In this example, the default attestation, i.e., that of a primary provider, is the appropriate one. The user then enters his/her password.

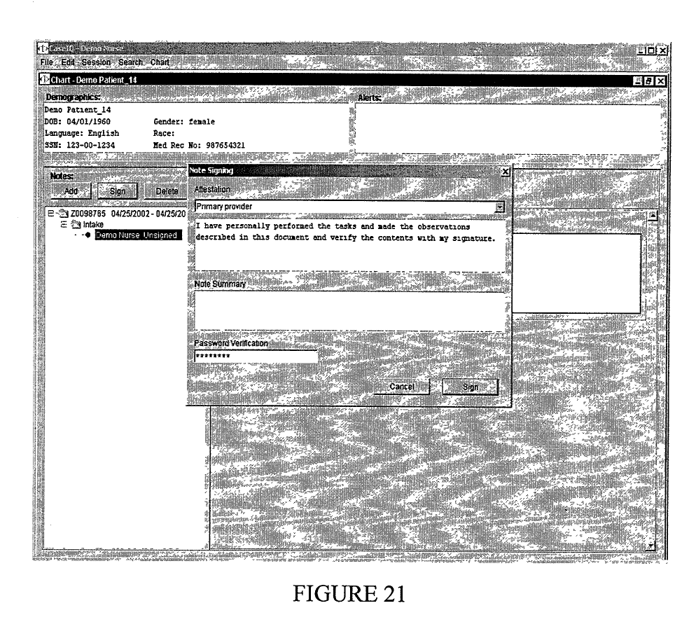

FIG. 21 depicts an illustrative screen that is viewed following the entry of the user's password. For security purposes, the actual password is not displayed, but rather a “*” is shown for each character of the password that has been entered. The user next clicks on the “Sign” button in the lower right of the Note Signing Popup.

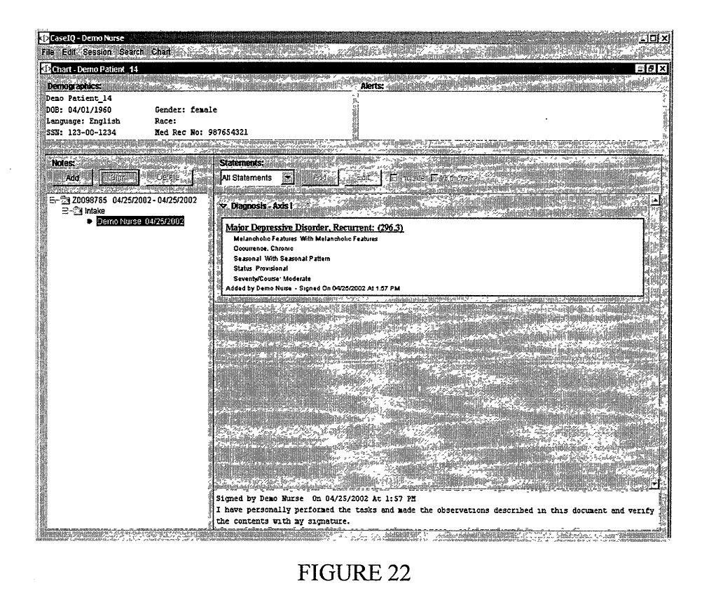

FIG. 22 depicts a further exemplary screen that is viewed following the signing of the note version. The highlighted note version in the Note Panel now shows the date of the signing of the note rather than the word “Unsigned.” In addition, the statement within the note version indicates that the note has been signed and provides the date and time of the signing. The attestation with which the note was signed, the name of the author of the note, and the date and time of the signing of the note are shown at the bottom of the Chart Pane.

FIG. 23 depicts what another user, Demo Doctor in this example, would see according to this illustrative embodiment of the present disclosure if he/she had opened the chart for patient Demo Patient_{—}14 after the user Demo Nurse had entered the diagnosis statement, but before the note version had been signed. This corresponds to the state of the system depicted in FIGS. 19 through FIG. 21. It is noteworthy that the presence of the unsigned Intake note and the fact that it is being authored by user Demo Nurse are evident, but the contents of the note are not visible.

FIG. 24 depicts what another user, again Demo Doctor in this example, would see according to this exemplary behavioral health system if he/she had opened the chart for patient Demo Patient_{—}14 after the note version had been signed. This corresponds to the state of the system depicted in FIG. 22. Of note, the contents of the Intake Note are now visible since the note version is now signed and the user Demo Doctor has, in this example, permission/authoriztion to see signed Intake Notes. In fact, according to the disclosed embodiment, Demo Doctor and Demo Nurse now see identical information about this note version. Except for their differing user names depicted at the top left of the screens, the screens depicted in FIGS. 22 and 24 are identical.

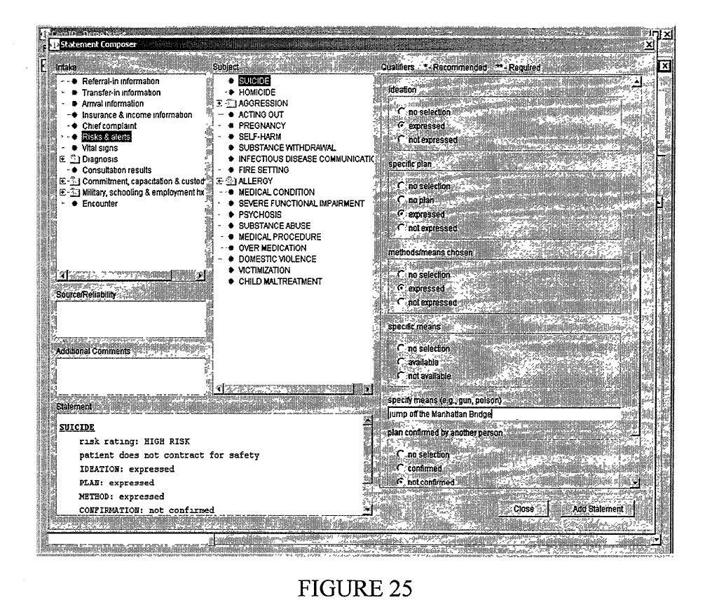

FIGS. 25-29 illustrate how, in this sample embodiment of the present disclosure, the Qualifier Panel on the right hand side of the Statement Composer changes based on the meta-data representing the type of statement the user has chosen to compose. That the system is an Electronic Patient Record system for the field of behavioral health is defined entirely through the metadata provided to the system rather than through traditional software.

As will be apparent to persons skilled in the art, the exemplary Electronic Patient Record system described herein above may be deployed through a variety of system architectures. For example, the EPR system may be deployed as part of a server/client network, and may be accessed through a variety of communication systems, e.g., across networks that constitute LAN, WAN or Internet-based systems or combinations thereof. Hardware requirements for deployment of the disclosed EPR system would be readily apparent to persons skilled in the deployment of applications of the type described herein.

It is also clear from the foregoing that the present method for creating document control versions provides an advancement in the art of document controls. While the invention has been described with respect to various specific embodiments, those skilled in the art will readily appreciate that various modifications, changes, and enhancements may be made thereto without departing from the spirit or scope of the present.

1. A system for managing information, comprising:
a database for storage of information;
at least one user interface for accessing information contained within and for supplying information to the database;
a processor in communication with the database and responsive to input from said at least one user interface, said processor being programmed to:
a) process data entries that are submitted by way of said at least one user interface for input to said database, each said data entry being processed as a transaction;
b) effectuate irrepudiability as to each said processed transaction, such that each said processed transaction is not modifiable;
c) identify a producer responsible for submitting said processed transaction with said processed transaction in said database; and
d) version data contained within said database such that a state of said database at a point in time reflects all processed transactions, applied in sequence as of said point in time.

2. A system according to claim 1, wherein said transaction involves data entry associated with creation of a file, modification of a file or deletion of a file.

3. A system according to claim 1, wherein said processor incorporates meta-data into said transaction to identify said producer with said processed transaction.

4. A system according to claim 1, wherein said processor incorporates meta-data into said transaction to reflect information related to said transaction, said related information being selected from the group consisting of an author's identity for said transaction, an effective date for information contained in said data entry, an attestation made by said author of said transaction, a creator's identity for said transaction, a modality of transmission of said information to said creator, a date of transmission of said information to said creator, and an attestation by said creator.

5. A system according to claim 1, wherein said processor is further programmed to identify a chain of responsibility for information contained within said processed transaction, said chain of responsibility being incorporated as meta-data into said processed transaction.

6. A system according to claim 5, wherein said chain of responsibility includes an identification of an entity responsible for at least one of the following tasks: acquiring said information, entering said information at the user interface, coding said information, translating said information, converting said information, and aggregating said information.

7. A system according to claim 6, wherein said entity is a human contributor, a non-human contributor, or a combination thereof.

8. A system according to claim 1, wherein said immutability of each said processed transaction permits modification of said processed transaction through controlled maintenance operations.

9. A system according to claim 1, wherein said state of said database at a point in time reflects infrastructure associated with processing of each of the processed transactions.

10. A system according to claim 9, wherein said infrastructure includes software codes, reference data and resources.

11. A system according to claim 10, wherein said reference data is selected from the group consisting of lookup tables, data input templates, data input menus, data input trees, and combinations thereof, and wherein said resources are selected from the group consisting of fonts, colors, formats, and computer hardware that includes workstations, network cards, network cables and communications links, and combinations thereof.

12. A system according to claim 10, wherein said infrastructure is associated with said processed transaction based on a unique reference or a unique pointer incorporated into said database.

13. A system according to claim 1, wherein said data entries relate to a healthcare information system, a mental healthcare information system, a behavioral health system, a financial system, an accounting system, a billing system, a design system, an inventory system, an industrial control system, a registration system or an enrollment system.

14. A system according to claim 1, wherein said data entries reflect information concerning a patient selected from the group consisting of the patient's medical history, treatment history, treatment approach, diagnosis, demographic information, medication and combinations thereof.

15. A system according to claim 1, wherein said processor is programmed to operate a presentation manager and a data manager.

16. A system according to claim 15, wherein said presentation manager functions to dynamically generate application screens for viewing and user interaction at said at least one user interface.

17. A system according to claim 15, wherein said data manager functions to process said data entries, effectuate irrepudiability as to each said processed transaction, identify said producer responsible for submitting said processed transaction, and version data contained within said database, and further functions to:
a) manage communications with the database;
b) manage updates to the database;
c) provide local, per user caching of data; and
d) provide data consistency despite data changes effectuated during a user session.

18. A system according to claim 1, wherein said database includes at least one structured vocabulary associated with the subject matter of the data entries.

19. A method for managing information, comprising:
receiving a data file via a computer network;
processing the data file to include meta-data that reflects information concerning the producer of the data file and ancillary information required to recreate the data file at a future point in time, said processed data file defining a transaction; and
storing the transaction in a database.

20. A method according to claim 19, wherein the ancillary information is selected from the group consisting of software codes, information on which the transaction was based, data views, maximum version reference, hardware configuration and combinations thereof.

21. A method according to claim 19, wherein the ancillary information is directly incorporated in the transaction as a collection of Java objects.

22. A method according to claim 19, wherein the data file is related to health care, mental health care, a financial or accounting system, or an industrial control system.
